(19) United States
(12) Patent Application Publication
(10) Pub. No.: US 2024/0420271 A1
(43) Pub. Date: Dec. 19, 2024

(54) INFORMATION PROCESSING APPARATUS, INFORMATION PROCESSING METHOD, AND PROGRAM

(71) Applicant: SONY GROUP CORPORATION, TOKYO (JP)

(72) Inventors: YASUHIRO HORI, TOKYO (JP); KIMINOBU NISHIMURA, TOKYO (JP); ATSUSHI UCHIDA, TOKYO (JP)

(21) Appl. No.: 18/706,450

(22) PCT Filed: Oct. 25, 2022
(86) PCT No.: PCT/JP2022/039649

§ 371 Date: May 1, 2024

(30) Foreign Application Priority Data
Nov. 8, 2021 (JP) 2021-181984

(51) Int. Cl. G06Q 50/43; G06Q 50/10

(52) U.S. Cl. CPC G06Q 50/43; G06Q 50/10

(57) ABSTRACT

The present disclosure relates to an information processing apparatus, an information processing method, and a program enabling recommendation of an appropriate rental vehicle to a user in using car sharing or car rental. An experience value including a travel distance is obtained for each feature item of a vehicle type of a vehicle of a user on the basis of a driving history, a matching degree of every selectable vehicle of the user is obtained on the basis of an experience value for each feature item, a recommended vehicle is selected in accordance with the matching degree, and recommendation information is generated together with a usage fee including an insurance premium in accordance with the matching degree. The present disclosure can be applied to a service of car sharing and car rental.

### TECHNICAL FIELD

The present disclosure relates to an information processing apparatus, an information processing method, and a program, and particularly to an information processing apparatus, an information processing method, and a program capable of recommending an appropriate rental vehicle to a user in using car sharing or car rental.

### BACKGROUND ART

There has been proposed a technology for recommending, as a rental vehicle, a vehicle that is likely to be comfortably driven on the basis of a stress index of a vehicle driven by a user in the past, in car sharing or car rental (see Patent Document 1).

### CITATION LIST

### Patent Document

Patent Document 1: Japanese Patent Application Laid-Open No. 2020-077085

### SUMMARY OF THE INVENTION

### Problems to be Solved by the Invention

However, in the technology described in Patent Document 1, a rental vehicle has not been recommended on the basis of a degree of driving experience according to a vehicle type and a vehicle rank and serving as a driving history of the user, and thus there has been a possibility that the rental vehicle cannot be appropriately recommended.

The present disclosure has been made in view of such a situation, and particularly, an object of the present disclosure is to enable appropriate recommendation of a rental vehicle on the basis of a driving history of a user in car sharing or car rental.

### Solutions to Problems

An information processing apparatus according to a first aspect of the present disclosure is an information processing apparatus including: an experience value calculation unit configured to calculate an experience value of a user on the basis of a driving history and a vehicle type of a vehicle driven by the user; and a generation unit configured to generate recommendation information of the vehicle on the basis of an experience value of the user.

An information processing method according to a first aspect of the present disclosure is an information processing method including: a step of calculating an experience value of a user on the basis of a driving history and a vehicle type of a vehicle driven by the user; and a step of generating recommendation information of the vehicle on the basis of an experience value of the user.

In the first aspect of the present disclosure, an experience value of a user is calculated on the basis of a driving history and a vehicle type of a vehicle driven by the user, and recommendation information of the vehicle is generated on the basis of an experience value of the user.

A program and an information processing apparatus according to a second aspect of the present disclosure are a program and an information processing apparatus including: a transmission unit configured to transmit a driving history and a vehicle type of a vehicle driven by a user to another information processing apparatus; and a recommendation unit configured to acquire and present recommendation information of the vehicle, the recommendation information being generated in the another information processing apparatus, on the basis of the vehicle type and the driving history.

An information processing method according to a second aspect of the present disclosure is an information processing method including: a step of transmitting a driving history and a vehicle type of a vehicle driven by a user to another information processing apparatus; and a step of acquiring and presenting recommendation information of the vehicle, the recommendation information being generated in the another information processing apparatus, on the basis of the vehicle type and the driving history.

In one aspect of the present disclosure, a driving history and a vehicle type of a vehicle driven by a user are transmitted to another information processing apparatus, and recommendation information of the vehicle generated in the another information processing apparatus is acquired and presented on the basis of the vehicle type and the driving history.

### BRIEF DESCRIPTION OF DRAWINGS

FIG. 1 is a diagram for explaining an outline of the present disclosure.

FIG. 2 is a table for explaining an experience value list of vehicle rank items.

FIG. 3 is a table for explaining an experience value list of equipment items.

FIG. 4 is a table for explaining an experience value list of characteristic items.

FIG. 5 is a table for explaining other examples of vehicle rank items, equipment items, and characteristic items for setting the experience value lists.

FIG. 6 is a table for explaining a matching level of vehicle rank items.

FIG. 7 is a table for explaining a matching level of characteristic items.

FIG. 8 is a table for explaining a calculation example of a matching degree.

FIG. 9 is a diagram for explaining a configuration example of a rental vehicle recommendation system according to a first embodiment of the present disclosure.

FIG. 10 is a block diagram for explaining a configuration example of a communication device.

FIG. 11 is a block diagram for explaining a configuration example of a car sharing/car rental service server.

FIG. 12 is a block diagram for explaining a configuration example of an insurance company server.

FIG. 13 is a flowchart for explaining driving history accumulation processing performed by the rental vehicle recommendation system of FIG. 9.

FIG. 14 is a flowchart for explaining rental vehicle presentation processing performed by the rental vehicle recommendation system of FIG. 9.

FIG. 15 is a view for explaining a display example of presentation information of a recommended vehicle.

FIG. 16 is a table for explaining a calculation example of a matching degree when a coefficient of a characteristic item of preference is increased.

FIG. 17 is a view for explaining a display example of presentation information of a recommended vehicle when a coefficient of a characteristic item of preference is increased.

FIG. 18 is a flowchart for explaining rental vehicle presentation processing when a coefficient of a characteristic item of preference is increased.

FIG. 19 is a flowchart for explaining driving history accumulation processing according to a first modification of the first embodiment.

FIG. 20 is a diagram for explaining a configuration example of a rental vehicle recommendation system according to a second embodiment of the present disclosure.

FIG. 21 is a flowchart for explaining rental vehicle presentation processing performed by the rental vehicle recommendation system of FIG. 20.

FIG. 22 is a block diagram illustrating a configuration example of a general-purpose computer.

### MODE FOR CARRYING OUT THE INVENTION

Hereinafter, preferred embodiments of the present disclosure will be described in detail with reference to the accompanying drawings. Note that, in the present specification and drawings, components having substantially the same functional configuration are denoted by the same reference numerals to avoid the description from being redundant.

A mode for carrying out the present technology will be described hereinafter. The description will be given in the following order.
1. Outline of present disclosure
2. First embodiment
3. First modification of first embodiment
4. Second modification of first embodiment
5. Second embodiment
6. Example of execution by software

### 1. Outline of Present Disclosure

The present disclosure is to enable appropriate recommendation of a rental vehicle based on a driving history of a user in car sharing or car rental.

In a case where a vehicle type that the user does not usually drive is selected in vehicle type selection at the time of renting a vehicle by using a service of car sharing or car rental, generally, a risk of an accident, damage, or the like occurring at the time of driving increases. Therefore, it is recommended to purchase a voluntary insurance when renting a vehicle in car sharing or car rental.

Here, in a case of selecting a familiar vehicle type to rent a vehicle, the risk of an accident, damage, and the like is lower than that in a case of renting a vehicle of an unfamiliar vehicle type. However, it is better to purchase a voluntary insurance in order to prepare in case of the risk of an accident, damage, and the like.

However, since the purchase of the insurance is optional, in a case where the user rents a vehicle of a familiar vehicle type, some users may become overconfident about their own driving and rent the vehicle without purchasing the insurance.

A business operator that lends a vehicle earnestly desires preparation in case of an accident or damage by increasing the number of users who purchase the voluntary insurance, but some users may not purchase an insurance in order to reduce cost related to renting a vehicle.

Whereas, an insurance premium is generally set according to a risk. For this reason, when a vehicle of a familiar vehicle type is rented out, it can be considered that the risk is lower than when a vehicle that is not familiar with is rented out. Therefore, the insurance premium when a vehicle of a familiar vehicle type is rented out should be set lower than the insurance premium when a vehicle that is not familiar with is rented out.

Therefore, in the present disclosure, by accumulating a driving history of a user, at the time of newly renting a vehicle, a matching degree indicating how much the user is familiar with each of lendable vehicles is obtained on the basis of the driving history, further, an insurance premium is set so as to be more discounted as a vehicle type is familiar on the basis of the matching degree, and an optimal rental vehicle is recommended and presented to the user in consideration of the matching degree and the discount of insurance premium.

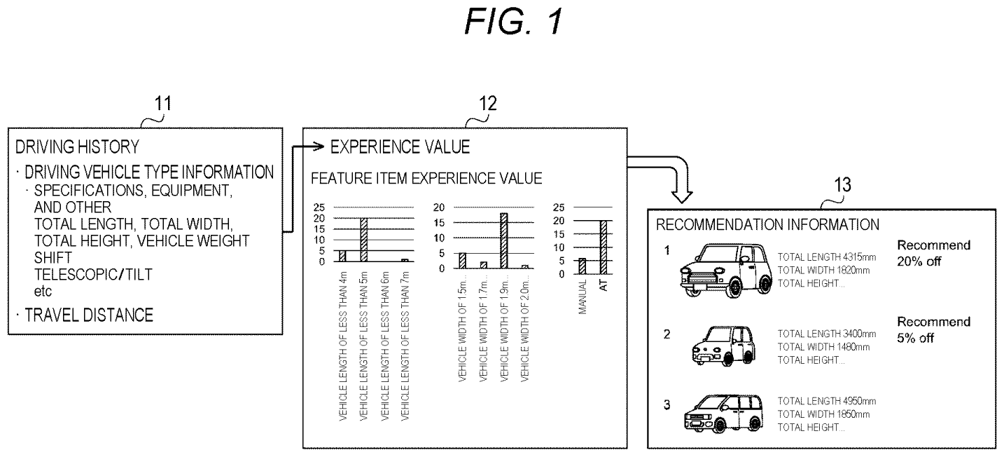

More specifically, in the present disclosure, first, when a user drives a vehicle, as illustrated in FIG. 1, a driving history 11 including driving vehicle type information and a travel distance is accumulated.

Here, the driving vehicle type information is information including multiple items expressing features of a vehicle driven by the user, and includes, for example, information about specifications and equipment of the vehicle.

Here, the information about the specifications is, for example, information including items representing features of a vehicle rank among features of the vehicle, such as a total length, a total width, a total height, and a vehicle weight of the vehicle.

The information about the equipment is, for example, information indicating a shift type indicating either manual transmission or automatic transmission, information indicating presence or absence of a telescopic function or a tilt function as a steering adjustment mechanism, and the like, and is information including items expressing features of provided equipment among features of the vehicle.

Note that, hereinafter, multiple items included in the driving vehicle type information and used to express the features of the vehicle are also referred to as feature items. Furthermore, among these feature items, an item expressing a feature of the vehicle rank is referred to as a vehicle rank item, and an item expressing a feature of the equipment is referred to as an equipment item. Therefore, the driving vehicle type information includes multiple feature items driven by the user, and the feature items include the vehicle rank item and the equipment item.

Next, an experience value 12 is obtained for each feature item on the basis of the driving history 11 for each user.

The experience value 12 in FIG. 1 is obtained by adding a travel distance as the experience value, for each feature item which is driving vehicle type information constituting the driving history 11 described above. For example, the experience value 12 in FIG. 1 is obtained by adding a travel distance as the experience value for each of the total length and the total width as the vehicle rank items and the shift type as the equipment item, among the feature items constituting the driving vehicle type information.
which are four types are provided for the total length of the experience value 12, which are less than 4 m, less than 5 m, less than 6 m, and 6 m or more from the left in the figure, and a travel distance of a vehicle having each total length is sequentially added and registered as the experience value.

More specifically, in the experience value 12 in FIG. 1, there is registration individually of, as the experience value, having traveled 5 km by driving a vehicle having a total length of less than 4 m, having traveled 20 km by driving a vehicle having a total length of less than 5 m, having traveled 0 km by driving a vehicle having a total length of less than 6 m, and having traveled 1 km by driving a vehicle having a total length of 6 m or more.

Furthermore, four types are provided for the total width in the experience value 12, which are 1.5 m, 1.7 m, 1.9 m, and 2.0 m from the left in the figure, and a travel distance of a vehicle having each total width is sequentially added and registered as the experience value for the total width.

More specifically, in the experience value 12 in FIG. 1, there is registration individually of, as the experience value, having traveled 5 km by driving a vehicle having a total width of 1.5 m, having traveled 2 km by driving a vehicle having a total width of 1.7 m, having traveled 18 km by driving a vehicle having a total width of 1.9 m, and having traveled 1 km by driving a vehicle having a total width of 2.0 m.

Moreover, two types are provided for the shift type of the experience value 12, which are manual transmission (manual) and automatic transmission (AT) from the left in the figure, and a travel distance of each vehicle is registered as the experience value.

More specifically, in the experience value 12 in FIG. 1, having traveled 6 km by driving a manual vehicle and having traveled 20 km by driving an AT vehicle are individually registered as experience values.

Then, according to the experience values 12, a vehicle optimal for the user is selected from among lendable vehicles, and is recommended as a rental vehicle.

According to the experience values 12 in FIG. 1, it can be considered that a vehicle having a feature item having the highest experience value regarding the total length, the total width, and the shift is the vehicle that the user is most familiar with.

That is, in the case of FIG. 1, the user has the highest experience value for less than 5 m for the feature item of the total length, the highest experience value for 1.9 m for the feature item of the total width, and the highest experience value for AT for the feature item of the shift type.

Therefore, according to the information about the experience values 12, it can be considered that the user is familiar with the vehicle having the total length of less than 5 m, the total width of less than 1.9 m, and the shift type of AT.

Therefore, in the present disclosure, on the basis of the information about the experience value 12, recommendation information 13 of a rental vehicle is generated and presented in order from a vehicle type close to a condition that is considered to be familiar to the user among the lendable vehicles.

In the recommendation information 13 of FIG. 1, from the top, a vehicle having a total length of less than 4315 mm and a total width of 1820 mm, which is the closest to the condition that the total length is less than 5 m and the total width is 1.9 m, is presented as a rental vehicle having the first recommendation rank. Next, a vehicle having a total length of less than 3400 mm and a total width of 1480 mm is presented as a rental vehicle having the second recommendation rank. Moreover, a vehicle having a total length of less than 4950 mm and a total width of 1850 mm is presented as rental vehicle having the third recommendation rank.

Moreover, at this time, as a rental vehicle, since a risk is considered to be smaller for a vehicle having a condition closer to the condition of the vehicle that is familiar, an insurance premium is set at a discount, and thus a usage fee including the insurance premium is set to be reduced.

In FIG. 1, “Recommend 20% off” is displayed for the vehicle of the first recommendation rank closest to the information about the user's experience value 12, indicating that the usage fee including the insurance premium is discounted by 20% in consideration that the risk regarding driving is low since the vehicle is close to the condition of the vehicle that is familiar.

Furthermore, “Recommend 5% off” is displayed for the vehicle of the second recommendation rank close to the information about the user's experience value 12, indicating that the usage fee including the insurance premium is discounted by 5% in consideration that the risk regarding driving is low, since the vehicle is relatively close to the condition of the vehicle that is familiar although not as close as the vehicle of the first recommendation rank.

That is, by presenting the recommendation information 13, an optimal vehicle type as a rental vehicle that is familiar to the user in driving is recommended to the user at a higher rank as the user is more familiar with the vehicle type. Furthermore, at this time, for the vehicle type familiar in driving, it is presented that the usage fee is reduced by applying a discount to the insurance premium in consideration of a decrease in the risk regarding driving.

As a result, the user can recognize a rental vehicle of a vehicle type that is familiar to the user in driving and is easy to drive. Furthermore, the user can recognize that the vehicle of the vehicle type that is familiar to the user in driving and is easy to drive has a reduced risk of an accident or damage related to driving, and a discount amount of the insurance premium is set to be large, so that the user can use the vehicle at a low price.

As a result, on the basis of the experience value obtained from the driving history of the user, the user can receive a proposal of an optimal rental vehicle for the user, which is familiar to the user, easy to drive, has a low risk, and low cost among lendable vehicles.

### 2. First Embodiment

<Experience value list related to vehicle rank>

In the present disclosure, in car sharing or car rental, an experience value is obtained on the basis of a driving history of a user, a matching degree of each of lendable vehicles between with the user based on the experience value is obtained, and recommendation information of an appropriate rental vehicle according to the matching degree is presented.

Therefore, first, a description is given to an experience value list in which experience values regarding driving are collected for each feature item based on the driving history of the user.

The experience value is obtained as an integrated value of a travel distance for each feature item expressing a feature of the vehicle, such as a vehicle rank, equipment, and a characteristic specified from specifications and equipment of a vehicle driven by the user.

Note that, here, an example of a case will be described in which a travel distance is adopted as the experience value, but information other than the travel distance may be used as long as the value can express a degree of an experience related to driving of the user. For example, travel time, the number of times of traveling, a travel frequency, or the like may be used instead of the travel distance. The travel frequency is the number of times of traveling for a predetermined distance or more within a predetermined period, and is, for example, information about how many times a week there is driving for a travel distance of 10 km or more. It can be considered that the user is familiar and skilled as the travel frequency is higher. Furthermore, the travel distance, the travel time, the number of times of traveling, and the travel frequency may be used in combination.

The feature item expressing the feature of the vehicle further includes a characteristic item in addition to the vehicle rank item and the equipment item as described above. The vehicle rank item includes, for example, information indicating a size and a weight of the vehicle that has been driven, and specifically includes a total length, a total width, a total height, and a total vehicle weight.

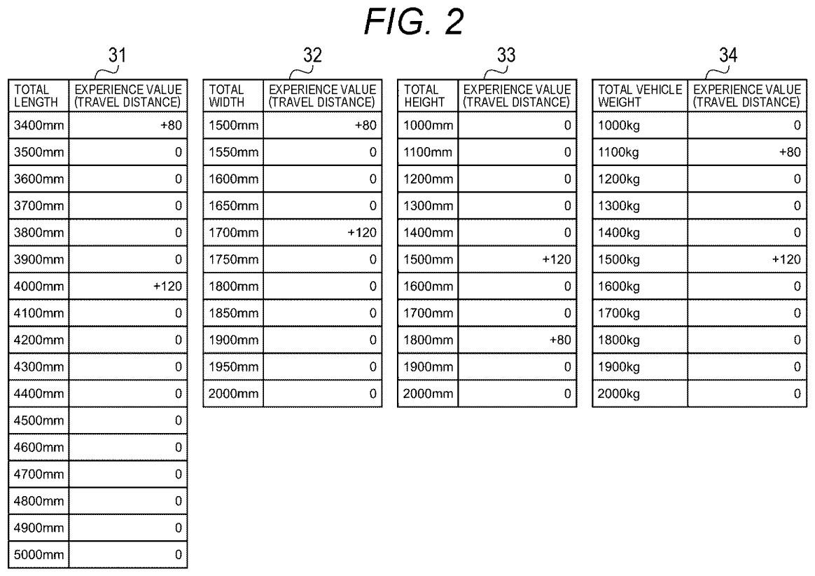

FIG. 2 illustrates an example of an experience value list obtained by listing individual experience values of vehicle rank items for each vehicle type of a vehicle included in a driving history of a vehicle driven by a predetermined user.

More specifically, FIG. 2 illustrates an example of an experience value list related to the vehicle rank items accumulated on the basis of a driving history of the predetermined user. FIG. 2 illustrates, from the left, an experience value list 31 for total length, an experience value list 32 for a total width, an experience value list 33 for a total height, and an experience value list 34 for a total vehicle weight.

In the experience value list 31, a total length of a vehicle driven by the user is illustrated on the left side, in which 3400 mm to 5000 mm are illustrated in intervals of 100 mm from the top to the bottom in the figure, and a travel distance in which the user drives a vehicle having the corresponding total length is illustrated on the right side as each experience value.

Note that, although the example in which the interval of the total length is 100 mm is illustrated here, an interval finer than 100 mm may be set or an interval coarser than 100 mm may be set. Furthermore, the intervals of other feature items described below are merely examples, and may be set in other intervals.

Here, for a vehicle type having a total length with a fraction within the interval of 100 mm, a length of less than 100 mm is rounded down. Therefore, for example, in a case where a total length is 3550 mm, the total length is regarded as 3500 mm. Furthermore, fractions are also rounded down for other items.

The experience value list 31 indicates having traveled 80 km by driving a vehicle having a total length of 3400 mm, having traveled 120 km by driving a vehicle having a total length of 4000 mm, and having never traveled by driving vehicles having other total lengths.

In the experience value list 32, a total width of a vehicle driven by the user is illustrated on the left side, in which 1500 mm to 2000 mm are illustrated in intervals of 50 mm from the top to the bottom in the figure, and a travel distance in which the user drives a vehicle having the corresponding total width is illustrated on the right side as each experience value.

The experience value list 32 indicates having traveled 80 km by driving a vehicle having a total width of 1500 mm, having traveled 120 km by driving a vehicle having a total width of 1700 mm, and having never traveled by driving vehicles having other total widths.

In the experience value list 33, a total height of a vehicle driven by the user is illustrated on the left side, in which 1000 mm to 2000 mm are illustrated in intervals of 100 mm from the top to the bottom in the figure, and a travel distance in which the user drives a vehicle having the corresponding total width is illustrated on the right side as each experience value.

The experience value list 33 indicates having traveled 120 km by driving a vehicle having a total height of 1500 mm, having traveled 80 km by driving a vehicle having a total height of 1800 mm, and having never traveled by driving vehicles having other total heights.

In the experience value list 34, a total vehicle weight of a vehicle driven by the user is illustrated on the left side, in which 1000 kg to 2000 kg are illustrated in intervals of 100 kg from the top to the bottom in the figure, and a travel distance in which the user drives a vehicle having the corresponding total vehicle weight is illustrated on the right side as each experience value.

The experience value list 34 indicates having traveled 80 km by driving a vehicle having a total vehicle weight of 1100 kg, having traveled 120 km by driving a vehicle having a total vehicle weight of 1500 mm, and having never traveled by driving vehicles having other total vehicle weights.

Note that, in the experience value list related to the vehicle rank item, an experience value (travel distance) for a predetermined size may be applied to experience values equal to or less than the experience value.

That is, for example, if the user has traveled by driving a vehicle having a total length longer than a predetermined total length, it may be regarded as an experience of traveling by driving a vehicle having a total length shorter than the predetermined total length.

Specifically, for a case where the experience value of traveling by driving a vehicle having a total length of 4000 mm is 120 km, it may be regarded that the user has also traveled 120 km by driving a vehicle having a total length of 4000 mm or less. Note that, in this case, for a vehicle having a total length of 3400 mm, there is an additional travel distance of 80 km as the experience value, and thus, 200 km may be set by adding both.

Furthermore, for example, if the user has traveled by driving a vehicle having a total width longer than a predetermined total width, it may be regarded as an experience of traveling by driving a vehicle having a total width shorter than the predetermined total width.

Specifically, for a case where the experience value of traveling by driving a vehicle having a total width of 1700 mm is 120 km, it may be regarded as the experience value of traveling 120 km by driving a vehicle having a total width of 1700 mm or less. Note that, in this case, for a vehicle having a total width of 1500 mm, there is an additional travel distance of 80 km as the experience value, and thus, 200 km may be set by adding both.

Moreover, for example, if the user has traveled by driving a vehicle having a total height higher than a predetermined total height, it may be regarded as an experience of traveling by driving a vehicle having a total height lower than the predetermined total height.

Specifically, for a case where the experience value of traveling by driving a vehicle having a total height of 1800 mm is 80 km, it may be regarded as the experience value of traveling 80 km by driving a vehicle having a total height of 1800 mm or lower. Note that, in this case, for a vehicle having a total height of 1500 mm, there is an additional travel distance of 120 km as the experience value, and thus, 200 km may be set by adding both for a vehicle having a total height of 1500 mm or lower.

Furthermore, for example, if the user has traveled a vehicle having a total vehicle weight heavier than a predetermined total vehicle weight, it may be regarded as an experience of traveling by driving a vehicle having a total vehicle weight heavier than the predetermined total vehicle weight.

Specifically, for a case where the experience value of traveling by driving a vehicle having a total vehicle weight of 1500 kg is 120 km, it may be regarded also as an experience value of traveling 120 km by driving a vehicle having a total vehicle weight of 1500 kg or less. Note that, in this case, for a vehicle having a total vehicle weight of 1100 kg, there is an additional travel distance of 80 km as the experience value, and thus, 200 km may be set by adding both for a vehicle having a total vehicle weight of 1100 kg or less.

### <Experience Value List Regarding Equipment>

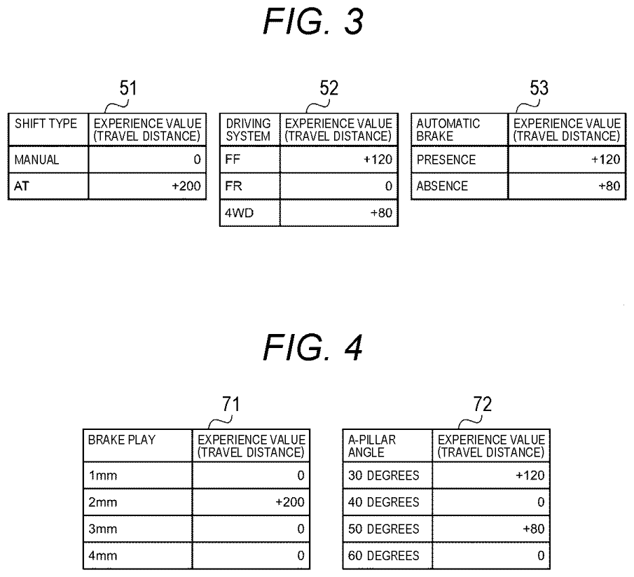

Next, with reference to FIG. 3, a description is given to an example of an experience value list obtained by listing individual experience values of equipment items for each vehicle type of a vehicle included in a driving history of a vehicle driven by the user.

More specifically, FIG. 3 illustrates an example of an experience value list related to the equipment items accumulated on the basis of a driving history of a predetermined user. FIG. 3 illustrates, from the left, an experience value list 51 for a shift type, an experience value list 52 for a driving system, and an experience value list 53 for an automatic brake.

In the experience value list 51, a shift type of a vehicle driven by the user is illustrated on the left side, manual transmission (manual) and automatic transmission (AT) are illustrated from the top in the figure, and a travel distance of a vehicle of the corresponding shift type driven by the user is illustrated on the right side as each experience value.

The experience value list 51 indicates having never traveled by driving vehicles whose shift type is manual and having traveled 200 km by driving a vehicle whose shift type is the AT.

In the experience value list 52, a driving system of a vehicle driven by the user is illustrated on the left side, in which front engine front drive (FF), front engine rear drive (FR), and four wheel drive (4WD) are illustrated from the top in the figure, and a travel distance of a vehicle of the corresponding driving system driven by the user is illustrated on the right side as each experience value.

The experience value list 52 indicates having traveled 120 km by driving a vehicle having a driving system of FF, having never traveled by driving vehicles having a driving system of FR, and having traveled 80 km by driving a vehicle having a driving system of 4WD.

In the experience value list 53, presence or absence of an automatic brake of a vehicle driven by the user is illustrated on the left side, in which presence and absence of the automatic brake are illustrated from the top in the figure, and a travel distance in which the user drives a vehicle equipped with the function of the automatic brake and a vehicle not equipped with the function of the automatic brake is illustrated on the right side as each experience value.

The experience value list 53 indicates having traveled 120 km by driving a vehicle with automatic brake and having traveled 80 km by driving a vehicle without automatic brake.

As for the equipment item, unlike the vehicle rank item, presence or absence of an item that can be covered as the experience value differs depending on other items, and thus determination according to the item is required.

For example, an experience value of traveling by driving a vehicle with a manual shift system may be regarded as the experience value of traveling by driving an AT vehicle, but an experience value of traveling by driving an AT vehicle cannot be regarded as the experience value of traveling by driving a manual vehicle.

Furthermore, an experience value for a vehicle not equipped with the automatic brake may be regarded as an experience value for a vehicle equipped with the automatic brake. In this case, the experience value for the vehicle not equipped with the automatic brake may be 200 km obtained by adding both as the experience values.

However, since the driving systems are independent from each other, it can be considered that experience values cannot be covered with each other.

### <Experience Value List Regarding Characteristic>

Next, with reference to FIG. 4, a description is given to an example of an experience value list obtained by listing individual experience values of characteristic items for each vehicle type of a vehicle included in a driving history of a vehicle driven by the user.

More specifically, FIG. 4 illustrates an example of an experience value list related to the characteristic items accumulated on the basis of a driving history of a predetermined user.

FIG. 4 illustrates, from the left, an experience value list 71 for a brake play, which is a distance until a brake pedal actually operates a brake, and an experience value list 72 for an A-pillar angle, which indicates an angle formed by pillars called A-pillars supporting both ends of a windshield of the vehicle.

Note that left and right fields of view during driving become narrower as the A-pillar angle is narrower, and conversely, the left and right fields of view during driving become wider as the A-pillar angle is wider. Therefore, the A-pillar angle is an item that can be considered as one of indices indicating the width of the left and right fields of view during driving.

In the experience value list 71, a brake play of a vehicle driven by the user is illustrated on the left side, in which 1 mm to 4 mm are illustrated in intervals of 1 mm from the top in the figure, and a travel distance in which the user drives a vehicle having the corresponding brake play is illustrated on the right side as each experience value.

The experience value list 71 indicates having traveled 200 km by driving a vehicle having a brake play of 2 mm, and having never traveled by driving vehicles having other brake plays.

In the experience value list 72, an A-pillar angle of a vehicle driven by the user is illustrated on the left side, in which 30 degrees to 60 degrees are illustrated in intervals of 10 degrees from the top in the figure, and a travel distance in which the user drives a vehicle having the corresponding A-pillar angle is illustrated on the right side as each experience value.

The experience value list 72 indicates having traveled 120 km by driving a vehicle having an A-pillar angle of 30 degrees, having traveled 80 km by driving a vehicle having an A-pillar angle of 50 degrees, and having never traveled by driving vehicles having other A-pillar angles.

As for the characteristic item, unlike the vehicle rank item, presence or absence of an item that can be covered as the experience value differs depending on other items, and thus determination according to the item is required. For example, the brake play may be regarded as the experience value as being closer to that of a familiar vehicle. Furthermore, the A-pillar angle affects a width of a field of view during driving. Therefore, numerically narrower field of view may be regarded as an experience value for a vehicle having a wider field of view.

### <Item Example of Experience Value>

In the above description, as an example of an experience value item, an example has been described in which a total length, a total width, a total height, and a total vehicle weight are used as the vehicle rank items, a shift type, a driving system, and presence or absence of an automatic brake are used as the equipment items, and a brake play and an A-pillar angle (width of a field of view) are used as the characteristic items, but other items may be used.

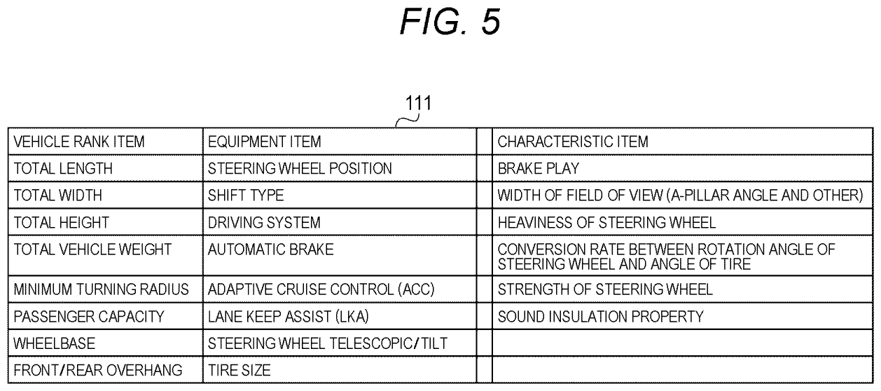

For example, as illustrated in a list 111 of FIG. 5, the vehicle rank items may include a minimum turning radius, a passenger capacity, wheelbase, front/rear overhang, and the like, in addition to the total length, the total width, the total height, and the total vehicle weight.

Furthermore, the equipment items may include a steering wheel position, presence or absence of adaptive cruise control (ACC), presence or absence of lane keep assist (LKA), steering wheel telescopic/tilt, a tire size, and the like, in addition to the shift type, the driving system, and the presence or absence of the automatic brake.

Moreover, the characteristic items may include heaviness of a steering wheel, a conversion rate between a rotation angle of the steering wheel and an angle of a tire, strength of a brake, a sound insulation property, and the like, in addition to the brake play and the A-pillar angle (width of a field of view).

### <Matching Degree>

Next, a description will be given to a method for calculating a matching degree for every user and every vehicle type based on an experience value registered in an experience value list obtained from a driving history of the user.

Here, the matching degree indicates a degree of being accustomed of the user to driving for each vehicle type based on the experience value obtained from the driving history of the user, in other words, an index indicating how much the vehicle type is similar to a vehicle type familiar to the user, for every vehicle type.

Therefore, in a case where the matching degree of a specific vehicle type between with the user is higher than a predetermined value, the user can be regarded as being relatively familiar with driving of a vehicle of the specific vehicle type, and a risk during driving can be regarded as being smaller than a predetermined risk.

Conversely, in a case where the matching degree of a specific vehicle type between with the user is lower than a predetermined value, the user can be regarded as being relatively unfamiliar with driving of a vehicle of the specific vehicle type, and a risk during driving can be regarded as being larger than a predetermined risk.

More specifically, the matching degree is calculated by the following Equation (1).

$$D = Dr \times Cr + De \times Ce + Dc \times Cc \qquad ( 1 )$$

Here, D is an overall matching degree of a predetermined vehicle type, Dr is a matching degree related to the vehicle rank item, and Cr is a coefficient related to the vehicle rank item, De is a matching degree for the equipment item, Ce is a coefficient related to the equipment item, Dc is a matching degree related to the characteristic item, and Cc is a coefficient related to the characteristic item.

Furthermore, the matching degree Dr related to the vehicle rank item is calculated by the following Equation (2).

$$Dr = Σ Gri \times Cri \qquad ( 2 )$$

Here, Gri is a matching level of a vehicle rank item i, Cri is a coefficient of the vehicle rank item i, and Σ represents an integrated value regarding Gri×Cri of all the vehicle rank items i.

Moreover, the matching degree De related to the equipment item is calculated by the following Equation (3).

$$De = Σ Gej \times Cej \qquad ( 3 )$$

Here, Gej is a matching level for an equipment item j, Cej is a coefficient for the equipment item j, and Σ represents an integrated value regarding Gej×Cej for all equipment items j.

Furthermore, the matching degree Dc related to the characteristic item is calculated by the following Equation (4).

$$Dc = Σ Gck \times Cck \qquad ( 4 )$$

Here, Gck is a matching level of a characteristic item k, Cck is a coefficient of the characteristic item k, and Σ represents an integrated value regarding Gck×Cck of all the characteristic items k.

### <Matching Level>

Here, the matching level Gri of the vehicle rank item i, the matching level Gej of the equipment item j, and the matching level Gck of the characteristic item k will be described.

The matching level is a value indicating how familiar the user is with each of the vehicle rank item, the equipment item, and the characteristic item, and is a value set on the basis of the experience value obtained from a driving history, and is set to, for example, a value of 0 to 1.

That is, the matching level is 1 for an item with which a travel distance as the experience value is longer than a predetermined distance, the user is familiar in driving, and the user can be regarded as sufficiently skilled. Conversely, in accordance with the travel distance as the experience value, a matching level is set to 0 to 1 for an item with which the travel distance as the experience value is shorter than a predetermined distance and the user can be regarded as being not skilled. Then, for an item with which the experience value is 0 and the user has never traveled, the user is regarded as being not skilled, and the matching level is set to 0.

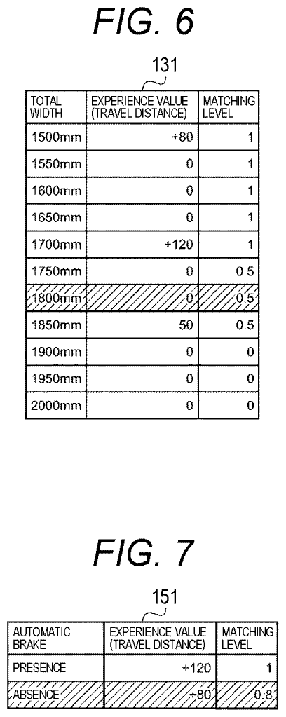

For example, as indicated by an experience value list 131 in FIG. 6 related to an item of a total width based on a driving history of a predetermined user, consider a case of having traveled 80 km by driving a vehicle having a total width of 1500 mm, having traveled 120 km by driving a vehicle having a total width of 1700 mm, having traveled 50 km by driving a vehicle having a total width of 1850 mm, and having never traveled by driving vehicles having other total widths.

Here, the experience value list 131 in FIG. 6 illustrates that the predetermined user has traveled 120 km, which is the longest, by driving a vehicle having a total width of 1700 mm, then has traveled 80 km by driving a vehicle having a total width of 1500 mm, and then has traveled 50 km by driving a vehicle having a total width of 1700 mm.

As a result, the predetermined user can be considered to be familiar most with traveling by driving the vehicle of 1700 mm.

Furthermore, if the user can be regarded as being sufficiently familiar with and skilled in driving a vehicle having the corresponding total width as long as the user has traveled about 100 km, the experience value exceeding 100 km can be assumed as an index for considering the user as being skilled. Furthermore, in the case of the experience value list 131, it can be considered that the user is familiar with and skilled in driving the vehicle having the total width of 1700 mm or less.

Therefore, the matching level is set to 1 for a vehicle having an experience value exceeding 100 km regarded as a predetermined index and having the total width of 1700 mm or less, which is the vehicle rank item with which the user can be regarded as being skilled in driving.

Furthermore, for an experience value up to 50 km which is a half distance of 100 km serving as the predetermined index, the user cannot be regarded as being skilled. However, since the user has experience, the matching level is set to 0.5 corresponding to the travel distance as the experience value. That is, in FIG. 6, the matching level is set to 0.5 for a vehicle having an experience value of 50 km, and a total width of 1850 mm or less and 1750 mm or more.

Moreover, the matching level is set to 0 for other vehicles having total widths for which the experience value is considered to be 0.

Furthermore, for example, as indicated by an experience value list 151 in FIG. 7 of an item regarding the presence or absence of the automatic brake, consider a case of having traveled 120 km by driving a vehicle equipped with the automatic brake and having traveled 80 km by driving a vehicle not equipped with the automatic brake.

Again, the matching level is set to 1 for a vehicle for which an experience value exceeds 100 km regarded as the predetermined index and that is equipped with automatic brake, which is the equipment item with which the user can be regarded as being skilled in driving.

Furthermore, for an experience value up to 80 km, which is 8/10 distance of 100 km serving as the predetermined index, the user cannot be regarded as being skilled. However, since the user has experience, a matching level is set to 0.8 corresponding to the travel distance as the experience value.

In this manner, the matching level Gri of the vehicle rank item i, the matching level Gej of the equipment item j, and the matching level Gck of the characteristic item k are set on the basis of information about the experience value list of each of the vehicle rank item, the equipment item, and the characteristic item recorded according to the driving history.

Note that, here, an example has been described in which the experience value is set to 0 for a total width with no experience of traveling. However, in a case where a size for which the matching level is set to 1 is slightly exceeded, the matching level may be set such that the matching level is attenuated from 1 by a coefficient corresponding to a degree of an excess amount.

For example, in a case of a user having experience of driving a vehicle having a total width of up to 1800 mm, in the example above, a matching level of a vehicle having a total width of up to 1800 mm is set to 1, and a matching level of a vehicle having a total width exceeding 1850 mm is set to 0.

However, if the user has experience of driving a vehicle with the total width of up to 1800 mm, the person can be considered to have superior experience in driving a vehicle with a total width of 1850 mm as compared with persons who have no experience of driving vehicles with other total widths.

Therefore, for example, for the vehicle having the total width of 1850 mm, a matching level (=a matching level 1×coefficient) may be calculated by multiplying a matching level of a vehicle having a total width of 1800 mm set to 1 by a coefficient corresponding to 50 mm that is the value of an excess amount.

More specifically, the coefficient may be decreased by 1 to 0.1 every time the total width exceeds, by 10 mm, a size for which the matching level is set to 1, in which, in a case where the matching level of a vehicle having a total width of 1800 mm is 1, a matching level of a vehicle having a total width of 1850 mm may be set to 0.5 (=1×(1−(0.1×5))), and a matching level of a vehicle having a total width of 1900 mm may be set to

$$0 ( = 1 \times ( 1 - ( 0.1 \times 10 ) ) ) .$$

Furthermore, this is not limited to the total width, and coefficients may be similarly set also for other feature items to set the matching level. Moreover, the setting of the coefficient is also merely an example, and the coefficient may be set by other techniques as long as the coefficient is set according to a degree of the excess amount.

### (Calculation Example of Matching Degree)

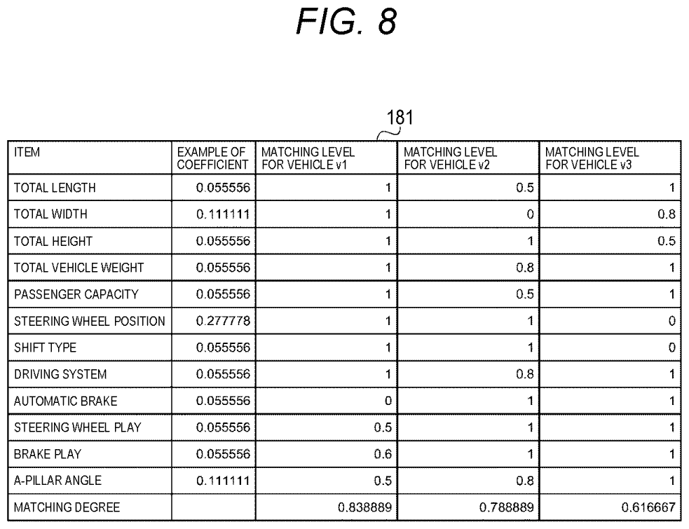

Next, with reference to a list 181 of FIG. 8, a calculation example of a matching degree will be described.

The list 181 of FIG. 8 illustrates a calculation example of a matching degree in a case where a predetermined coefficient is set for each of the vehicle rank item, the equipment item, and the characteristic item, and a predetermined matching level is set for each of vehicles V1 to V3.

FIG. 8 illustrates, from the left, the vehicle rank items, the equipment items, and the characteristic items for which experience values based on the driving history are obtained, examples of coefficients of the individual items, and examples of matching levels for the vehicles V1 to V3, and illustrates calculation examples of matching degrees of the vehicles V1 to V3 in the bottom row.

In the leftmost column of FIG. 8, a total length, a total width, a total height, a total vehicle weight, a passenger capacity, a steering wheel position, a shift type, a driving system, an automatic brake, a steering wheel play, a brake play, and an A-pillar angle are set from the top as the individual items of the vehicle rank item, the equipment item, and the characteristic item for which the experience values based on the driving history are obtained.

Furthermore, the second column from the left in FIG. 8 illustrates setting examples such as 0.055556, 0.111111, 0.055556, 0.055556, 0.055556, 0.277778, 0.055556, 0.055556, 0.055556, 0.055556, 0.055556, and 0.111111 from the top, as examples of the coefficients set for individual items for which the experience values are obtained.

Note that the coefficient is set according to a degree of importance in obtaining the matching degree expressing a degree of being accustomed of the user to driving. In the example of FIG. 8, regarding the steering wheel position, the total width, and the A-pillar angle which have a relatively large influence by driving a vehicle feeling, values larger than those of other feature items are set. In particular, the coefficient of the steering wheel position is set to the largest value. However, this coefficient is merely an example, and other coefficients may be set, and a magnitude relationship of the coefficients set for the feature items is not limited thereto.

Moreover, the third column from the left in FIG. 8 illustrates setting examples such as 1, 1, 1, 1, 1, 1, 1, 1, 0, 0.5, 0.6, and 0.5 from the top, as the matching level for the vehicle V1.

Furthermore, the fourth column from the left in FIG. 8 illustrates setting examples such as 0.5, 0, 1, 0.8, 0.5, 1, 1, 0.8, 1, 1, 1, and 0.8 from the top, as the matching level for the vehicle V2.

Moreover, the rightmost column of FIG. 8 illustrates setting examples such as 1, 0.8, 0.5, 1, 1, 0, 0, 1, 1, 1, 1, and 1 from the top, as the matching level for the vehicle V3.

Then, the bottom row illustrates, from the left, the matching degrees of the vehicles V1 to V3 obtained as a product-sum of the coefficient of each item and the matching level, and 0.838889, 0.788889, and 0.616667 are obtained, respectively.

More specifically, as an example of the coefficients set for individual items, 0.055556, 0.111111, 0.055556, 0.055556, 0.055556, 0.277778, 0.055556, 0.055556, 0.055556, 0.055556, 0.055556, and 0.111111 are set from the top, and the matching level of the vehicle V1 is set to 1, 1, 1, 1, 1, 1, 1, 1, 0, 0.5, 0.6, and 0.5 from the top.

Therefore, the matching degree of the vehicle V1 is

$$calculated as 0.055556 \times 1 + 0.111111 \times 1 + 0.055556 \times 1 + 0.055556 \times 1 + 0.055556 \times 1 + 0.277778 \times 1 + 0.055556 \times 1 + 0.055556 \times 1 + 0.055556 \times 0 + 0.055556 \times 0.5 + 0.055556 \times 0.6 + 0.111111 \times 0.5 = 0.838889 .$$

Furthermore, the matching degree of the vehicle V2 is

$$calculated as 0.055556 \times 0.5 + 0.111111 \times 0 + 0.055556 \times 1 + 0.055556 \times 0.8 + 0.055556 \times 0.5 + 0.277778 \times 1 + 0.055556 \times 1 + 0.055556 \times 0.8 + 0.055556 \times 1 + 0.055556 \times 1 + 0.055556 \times 1 + 0.111111 \times 0.8 = 0.788889 .$$

Similarly, the matching degree of the vehicle V3 is

$$calculated as 0.055556 \times 1 + 0.111111 \times 0.8 + 0.055556 \times 0.5 + 0.055556 \times 1 + 0.055556 \times 1 + 0.277778 \times 0 + 0.055556 \times 0 + 0.055556 \times 1 + 0.055556 \times 1 + 0.055556 \times 1 + 0.055556 \times 1 + 0.111111 \times 1 = 0.616667 .$$

Note that, here, it is assumed that Cr (=ΣCri)+Ce (=ΣCej)+Cc (=ΣCck)=1 is satisfied. Furthermore, ΣCri, ΣCej, and ΣCck are a sum of all pieces of i of the coefficients Cri of the vehicle rank item i, a sum of all pieces of j of the coefficients Cej of the equipment item j, and a sum of all pieces of k of the coefficients Cck of the characteristic item k, respectively. However, this is an example, and other values may be set for the setting of various coefficients.

As a result, a rental vehicle is recommended to the user in the order of the vehicles V1, V2, and V3 in the descending order of the matching degree.

Furthermore, when a rental vehicle is recommended, a usage fee including an insurance premium set for the rental vehicle is also presented. The insurance premium is generally set according to a skill level for a vehicle driven by the user. That is, substantially, the insurance premium set for the rental vehicle is set to a lower amount as the matching degree is higher. Therefore, for example, a discount corresponding to the matching degree may be set for a general insurance premium set for a rental vehicle, and the usage fee may be set so as to be lower as the matching degree is higher.

By doing this way, the user can receive recommendation of a rental vehicle that is familiar in driving and is easier to drive, in accordance with the matching degree. Furthermore, in accordance with the matching degree, the user can receive recommendation of a rental vehicle with a low risk of an accident, damage, or the like occurring during driving since the user is familiar with driving, and with a lower usage fee including an insurance premium. By being presented with the usage fee in consideration of the matching degree and the discount amount of the insurance premium when receiving recommendation of a rental vehicle, the user can receive recommendation of a rental vehicle that is easier for the user to drive and is lower in cost.

As a result, it is possible to receive recommendation of an optimal rental vehicle for the user in car sharing or car rental, so that the user can easily select the optimal rental vehicle.

### <Configuration Example of Rental Vehicle Recommendation System>

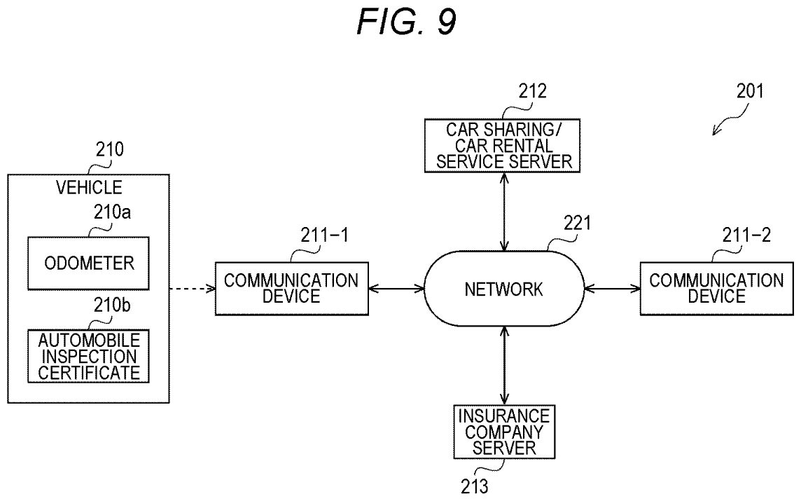

Next, with reference to FIG. 9, a configuration example of a rental vehicle recommendation system that implements the above-described technology of the present disclosure will be described.

A rental vehicle recommendation system 201 in FIG. 9 includes communication devices 211-1 and 211-2, a car sharing/car rental service server 212, and an insurance company server 213, which are able to communicate with each other via a network 221 including the Internet, a public line, or the like.

The communication device 211-1 is, for example, a communication terminal such as a smartphone carried by a user who rents a rental vehicle by using a service such as car sharing or car rental.

The communication device 211-1 accesses the car sharing/car rental service server 212 to conclude various contracts related to car sharing or car rental service, in association with user management information for identifying a user who possesses the communication device 211-1.

As a result, the car sharing/car rental service server 212 manages the user who has concluded the contract related to the car sharing or the car rental service by using the user management information via the communication device 211-1, and executes payment or the like related to service provision.

The communication device 211-1 is a mobile terminal represented by a smartphone, and notifies the car sharing/car rental service server 212 of an end of driving via the network 221, when the rental vehicle is returned. At this time, the communication device 211-1 also notifies the car sharing/car rental service server 212 of the user management information for identifying the user. When notified of the end of driving, the car sharing/car rental service server 212 presents information prompting a staff member of the car sharing/car rental service to read out information serving as a driving history.

The information serving as the driving history is, for example, regarding a vehicle 210 which is a rental vehicle, a value of an odometer at a start of driving, a value of the odometer at an end of driving, and information about an automobile inspection certificate (vehicle verification) 210b as information for individually identifying the vehicle 210. That is, when the rental vehicle is returned, the staff member of the car sharing/car rental service reads out the information about the vehicle inspection certificate and the value of the odometer at the end of driving of the rental vehicle as the information about the driving history, and inputs the information to the car sharing/car rental service server 212.

Note that the read value of the odometer is the value of the odometer at the end of driving of the user who has used the rental vehicle until immediately before, and simultaneously is the value of the odometer at a start of driving by a user who will use the rental vehicle next.

The communication device 211-2 is basically the same communication terminal device as the communication device 211-1, is possessed by the user who has concluded the contract related to the car sharing/car rental service, and requests the car sharing/car rental service server 212 to present recommendation information of a rental vehicle together with the user management information in order to receive provision of the car sharing/car rental service.

Furthermore, the communication device 211-2 acquires recommendation information of a rental vehicle corresponding to this request from the car sharing/car rental service server 212, and presents the recommendation information to the user.

Note that the communication devices 211-1 and 211-2 are basically the same portable communication terminals and also have the same functions, and thus will be simply referred to as a communication device 211 in a case where it is not particularly necessary to distinguish from each other.

However, for convenience of description, in the description of the present embodiment, it is assumed that the communication device 211-1 is carried by the user when driving a rental vehicle of the car sharing/car rental service, and is used to transmit information regarding the driving history to the car sharing/car rental service server 212.

Furthermore, it is assumed that the communication device 211-2 is possessed by a user who is going to use the car sharing/car rental service from now on, and is used to receive presentation of recommendation information of a rental vehicle.

As a matter of course, the communication device 211-2 also has a function of transmitting information regarding the driving history to the car sharing/car rental service server 212, and the communication device 211-1 also has a function of acquiring and presenting recommendation information of a rental vehicle.

Moreover, although an example is illustrated in which the rental vehicle recommendation system 201 of FIG. 2 includes only two communication devices 211 of the communication devices 211-1 and 211-2, it is premised that there are at least three or more communication devices 211 possessed by users who have concluded a contract related to the car sharing/car rental service, although not illustrated.

The car sharing/car rental service server 212 is a server operated by a business operator operating the car sharing/car rental service, and concludes a contract related to service provision via the communication devices 211-1 and 211-2 and manages the user management information acquired in the conclusion of the contract. Furthermore, the car sharing/car rental service server 212 manages a lending status of a rental vehicle and executes payment of a usage fee.

Upon acquiring the information regarding the driving history input by a staff member on the basis of a notification transmitted from the communication device 211-1, the car sharing/car rental service server 212 transmits the information to the insurance company server 213.

Furthermore, when recommendation information of a rental vehicle is requested by the communication device 211-2 in association with the user management information, the car sharing/car rental service server 212 supplies information about a lending status of a rental vehicle to the insurance company server 213 together with the user management information, and requests the recommendation information.

Moreover, upon acquiring the recommendation information supplied from the insurance company server 213, the car sharing/car rental service server 212 transmits the recommendation information to the communication device 211-2.

The insurance company server 213 is a server managed and operated by an automobile insurance company. The insurance company server 213 accumulates information about a driving history transmitted from the communication device 211-1 in association with the user management information via the car sharing/car rental service server 212.

Upon receiving the request for recommendation information of a rental vehicle transmitted from the communication device 211-2 in association with the user management information via the car sharing/car rental service server 212, the insurance company server 213 generates the recommendation information on the basis of the information about the driving history accumulated in association with the user management information.

Then, the insurance company server 213 transmits the generated recommendation information to the communication device 211-2 that has requested the recommendation information of a rental vehicle, via the car sharing/car rental service server 212.

More specifically, when the recommendation information of a rental vehicle is requested, the insurance company server 213 calculates an experience value for each of the vehicle rank item, the equipment item, and the characteristic item described above on the basis of the driving history accumulated in association with the user management information.

The insurance company server 213 calculates a matching level for each of the vehicle rank item, the equipment item, and the characteristic item on the basis of the experience value for each.

On the basis of the calculated matching level, the insurance company server 213 calculates a matching degree with respect to the user who has requested the recommendation information for each of lendable rental vehicles, on the basis of the information about the lending status supplied from the car sharing/car rental service server 212.

The insurance company server 213 sets a recommendation rank and an insurance premium of a lendable rental vehicle on the basis of the matching degree, generates recommendation information including information about a usage fee based on the set recommendation rank and an insurance premium of the rental vehicle, and transmits the recommendation information to the communication device 211-2.

### <Configuration Example of Communication Device>

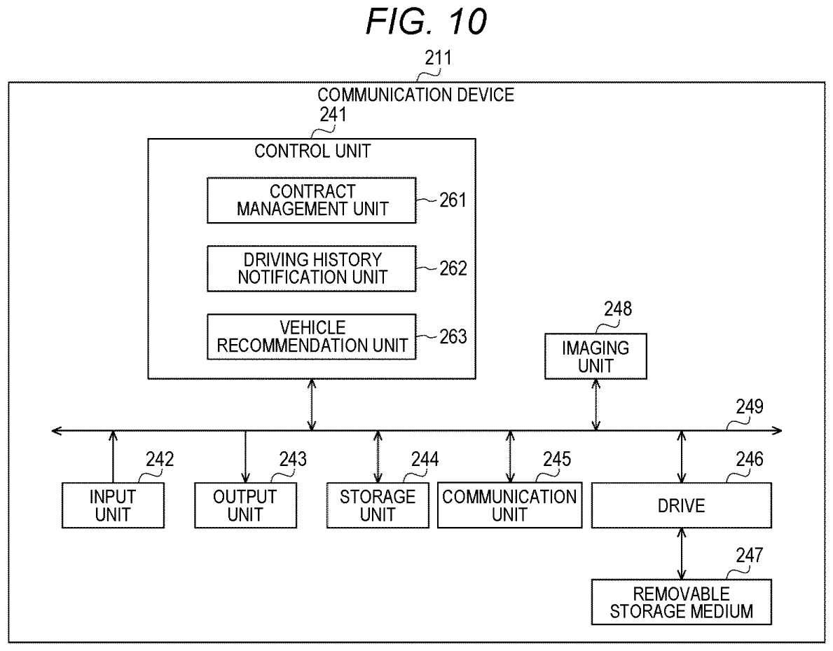

Next, with reference to FIG. 10, a configuration example of the communication device 211 will be described.

The communication device 211 includes a control unit 241, an input unit 242, an output unit 243, a storage unit 244, a communication unit 245, a drive 246, a removable storage medium 247, and an imaging unit 248, which are connected to each other via a bus 249 and can transmit and receive data and programs.

The control unit 241 includes a processor and a memory, and controls the entire operation of the communication device 211. Furthermore, the control unit 241 includes a contract management unit 261, a driving history notification unit 262, and a vehicle recommendation unit 263.

The contract management unit 261 executes processing related to conclusion of a contract related to the car sharing/car rental service, through communication with the car sharing/car rental service server 212. At this time, the contract management unit 261 stores the user management information of the user who possesses the communication device 211, and supplies the user management information to the car sharing/car rental service server 212 when the contract related to the car sharing/car rental service is concluded.

The driving history notification unit 262 controls the communication unit 245 to notify the car sharing/car rental service server 212 of an end of driving of a rental vehicle by the user who possesses the communication device 211.

The information serving as the driving history is values of the odometer at a start of driving and an end of driving, and information about a vehicle inspection certificate (automobile inspection certificate), of the rental vehicle driven by the user.

Therefore, when the notification of the end of driving is supplied, the car sharing/car rental service server 212 instructs a staff member of the car sharing/car rental service to read out and input the vehicle inspection certificate and the value of the odometer.

Note that, it suffices that the car sharing/car rental service server 212 is notified of the values of the odometer at the start of driving and the end of driving and information about the automobile inspection certificate of the rental vehicle driven by the user, which are the information serving as the driving history. Therefore, the user may read out the values of the odometer at the start of driving and the end of driving and the information about the automobile inspection certificate, and operate the input unit 242 to transmit the information to the car sharing/car rental service server 212.

When the user who possesses the communication device 211 requests recommendation information of a rental vehicle in receiving provision of the car sharing/car rental service and renting the rental vehicle, the vehicle recommendation unit 263 controls the communication unit 245 to request the recommendation information from the car sharing/car rental service server 212.

Furthermore, the vehicle recommendation unit 263 acquires the recommendation information transmitted from the car sharing/car rental service server 212 in response to the request for the recommendation information, and presents the recommendation information of the rental vehicle to the user by controlling the output unit 243.

In this manner, by presenting the recommendation information, the user can receive the presentation of a rental vehicle that is optimal for the user among rental vehicles that the user himself/herself intends to rent, regarding the car sharing/car rental service.

The input unit 242 includes an input device such as a keyboard, a mouse, or a touch panel through which an operation command is input, and supplies various input signals to the control unit 241.

The output unit 243 is controlled by the control unit 241 and includes a display unit and a voice output unit. The output unit 243 outputs an operation screen and an image of a processing result to the display unit including a display device configured by a liquid crystal display (LCD), an organic electro luminescence (EL), or the like for display. Furthermore, the output unit 243 controls the voice output unit including a voice output device to output various voices.

The storage unit 244 includes a hard disk drive (HDD), a solid state drive (SSD), a semiconductor memory, or the like, is controlled by the control unit 241, and writes or reads various data and programs.

The communication unit 245 is controlled by the control unit 241, implements communication represented by a local area network (LAN), Bluetooth (registered trademark), or the like in a wired or wireless manner, and transmits and receives various data and programs to and from various apparatuses via the network 221 as necessary.

The drive 246 reads and writes data from and to the removable storage medium 247 such as a magnetic disk (including a flexible disk), an optical disk (including a compact disc-read only memory (CD-ROM) and a digital versatile disc (DVD)), a magneto-optical disk (including a mini disc (MD)), a semiconductor memory, or the like.

The imaging unit 248 includes a complementary metal oxide semiconductor (CMOS) image sensor or the like, and is controlled by the control unit 241 to capture an image. At this time, for example, a value of the odometer at a start of driving, a value of the odometer at an end of driving, and information about an automobile inspection certificate of the vehicle driven by the user, which are information about the driving history, may be imaged by the imaging unit 248. That is, in this case, an image obtained by imaging the values of the odometer at the start of driving and the end of driving and the information about the automobile inspection certificate of the vehicle driven by the user may be transmitted as the information about the driving history to the car sharing/car rental service server 212.

### <Configuration Example of Car Sharing/Car Rental Service Server>

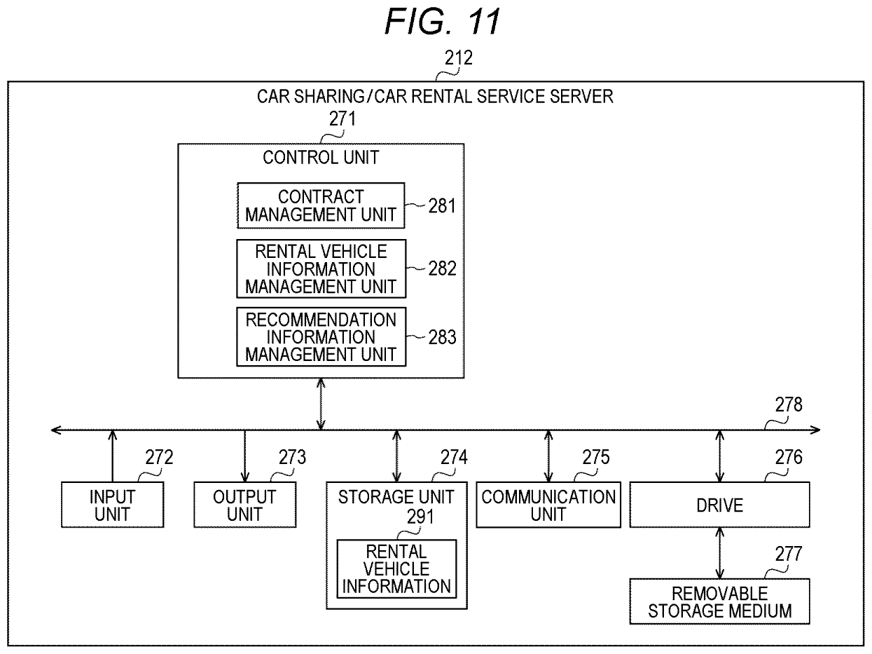

Next, with reference to FIG. 11, a configuration example of the car sharing/car rental service server 212 will be described.

The car sharing/car rental service server 212 includes a control unit 271, an input unit 272, an output unit 273, a storage unit 274, a communication unit 275, a drive 276, and a removable storage medium 277, which are connected to each other via a bus 278 and can transmit and receive data and programs.

The control unit 271 includes a processor and a memory, and controls the entire operation of the car sharing/car rental service server 212. Furthermore, the control unit 271 includes a contract management unit 281, a rental vehicle information management unit 282, and a recommendation information management unit 283.

The contract management unit 281 executes processing related to conclusion of a contract related to the car sharing/car rental service, through communication with the communication device 211 possessed by the user who intends to receive provision of the car sharing/car rental service.

At this time, the contract management unit 281 acquires and stores user management information for identifying a user who possesses the car sharing/car rental service server 212, and manages use of the car sharing/car rental service.

The rental vehicle information management unit 282 manages a lending status of a rental vehicle, by accessing the storage unit 274 to register, into rental vehicle information 291, information indicating a lending status such as, for example, being rented out or being lendable for the rental vehicle, in association with rental vehicle management information for individually identifying a rental vehicle owned for use in the car sharing/car rental service.

Note that, in a case where the rental vehicle is being rented out, the user management information of the user who is a renter is stored together with information indicating that the rental vehicle is being rented out, in association with the rental vehicle management information.

Moreover, when the rental vehicle that has been rented out is returned, the rental vehicle information management unit 282 updates the information with information indicating that the rental vehicle is lendable and stores the updated information. At this time, the rental vehicle information management unit 282 may update and store a value of the odometer of the rental vehicle at the time of return in association with the rental vehicle management information.

That is, the rental vehicle information management unit 282 stores and manages, in the rental vehicle information 291, information indicating whether the rental vehicle is not rented out and is lendable or has been rented out and is being rented out. At this time, the rental vehicle information management unit 282 may store and manage a value of the odometer at the time of return in the rental vehicle information 291, in association with the rental vehicle management information for identifying the rental vehicle.

When a rental vehicle is being rented out, the rental vehicle information management unit 282 registers the user management information of the user who is the renter into the rental vehicle information 291 together with the information indicating that the vehicle is being rented out, in association with the rental vehicle management information corresponding to the rental vehicle.

When recommendation information of a rental vehicle is requested from the communication device 211, the recommendation information management unit 283 reads out information about a lendable vehicle on the basis of the rental vehicle information 291, supplies the information to the insurance company server 213 together with the user management information of the user who has requested the recommendation information, and requests the recommendation information.

Upon acquiring the recommendation information transmitted from the insurance company server 213 in response to the request for the recommendation information, the recommendation information management unit 283 transmits the recommendation information to the communication device 211 that has requested the recommendation information.

The input unit 272 includes an input device such as a keyboard, a mouse, or a touch panel through which an operation command is input, and supplies various input signals to the control unit 271.

The output unit 273 is controlled by the control unit 271 and includes a display unit and a voice output unit. The output unit 273 outputs an operation screen and an image of a processing result to the display unit including a display device configured by a liquid crystal display (LCD), an organic electro luminescence (EL), or the like for display. Furthermore, the output unit 273 controls the voice output unit including a voice output device to output various voices.

The storage unit 274 includes a hard disk drive (HDD), a solid state drive (SSD), a semiconductor memory, or the like, is controlled by the control unit 271, and writes or reads various data and programs.

The communication unit 275 is controlled by the control unit 271, implements communication represented by a local area network (LAN), Bluetooth (registered trademark), or the like in a wired or wireless manner, and transmits and receives various data and programs to and from various apparatuses via the network 221 as necessary.

The drive 276 reads and writes data from and to the removable storage medium 277 such as a magnetic disk (including a flexible disk), an optical disk (including a compact disc-read only memory (CD-ROM) and a digital versatile disc (DVD)), a magneto-optical disk (including a mini disc (MD)), a semiconductor memory, or the like.

### <Configuration Example of Insurance Company Server>

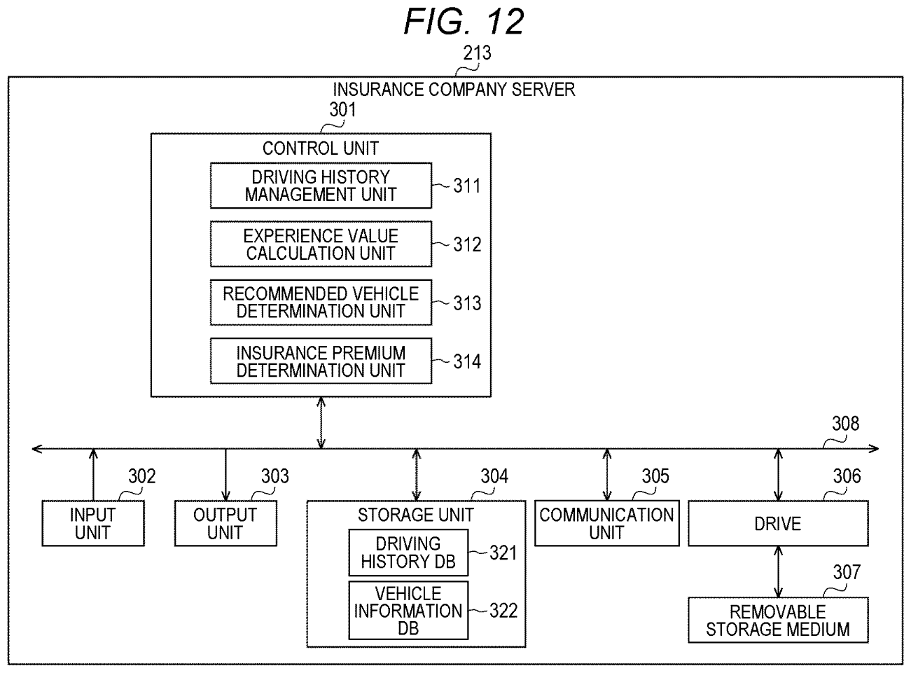

Next, with reference to FIG. 12, a configuration example of the insurance company server 213 will be described.

The insurance company server 213 includes a control unit 301, an input unit 302, an output unit 303, a storage unit 304, a communication unit 305, a drive 306, and a removable storage medium 307, which are connected to each other via a bus 308 and can transmit and receive data and programs.

The control unit 301 includes a processor and a memory, and controls the entire operation of the insurance company server 213. Furthermore, the control unit 301 includes a driving history management unit 311, an experience value calculation unit 312, a recommended vehicle determination unit 313, and an insurance premium determination unit 314.

The driving history management unit 311 acquires information about a driving history supplied from the car sharing/car rental service server 212 in association with the user management information, accesses the storage unit 304, and registers the information into a driving history database (DB) 321.

When recommendation information of a rental vehicle is requested together with user management information from the communication device 211 via the car sharing/car rental service server 212, the experience value calculation unit 312 accesses the storage unit 304 to read out a driving history corresponding to the user management information among information accumulated in the driving history DB 321, and calculates an experience value for each of the vehicle rank item, the equipment item, and the characteristic item.

At this time, for the information about the vehicle rank item, the equipment item, and the characteristic item of the vehicle driven by the user, the experience value calculation unit 312 searches a vehicle information DB 322 stored in the storage unit 304 on the basis of the information about the automobile inspection certificate included in the information about the driving history, and reads out necessary information. The vehicle information DB 322 stores information about the automobile inspection certificate, the vehicle rank items, the equipment items, and the characteristic items of the vehicle in association with the rental vehicle management information.

When recommendation information of a rental vehicle is requested together with the user management information from the communication device 211 via the car sharing/car rental service server 212, the recommended vehicle determination unit 313 calculates a matching degree of the user for each of lendable vehicles, on the basis of the experience value calculated by the experience value calculation unit 312 and the rental vehicle information for managing a lending status of the rental vehicle.

Then, the recommended vehicle determination unit 313 determines a recommendation rank on the basis of the matching degree of each of the lendable rental vehicles.

At this time, the insurance premium determination unit 314 sets an insurance premium of the lendable rental vehicle in accordance with the matching degree.

The recommended vehicle determination unit 313 generates recommendation information on the basis of the recommendation rank of the rental vehicle based on the matching degree and a usage fee in consideration of an insurance premium for each, and controls the communication unit 305 to transmit the recommendation information to the communication device 211 via the car sharing/car rental service server 212.

The input unit 302 includes an input device such as a keyboard, a mouse, or a touch panel through which an operation command is input, and supplies various input signals to the control unit 301.

The output unit 303 is controlled by the control unit 301 and includes a display unit and a voice output unit. The output unit 303 outputs an operation screen and an image of a processing result to the display unit including a display device configured by a liquid crystal display (LCD), an organic electro luminescence (EL), or the like for display. Furthermore, the output unit 303 controls the voice output unit including a voice output device to output various voices.

The storage unit 304 includes a hard disk drive (HDD), a solid state drive (SSD), a semiconductor memory, or the like, is controlled by the control unit 301, and writes or reads various data and programs.

The communication unit 305 is controlled by the control unit 301, implements communication represented by a local area network (LAN), Bluetooth (registered trademark), or the like in a wired or wireless manner, and transmits and receives various data and programs to and from various apparatuses via the network 221 as necessary.

The drive 306 reads and writes data from and to the removable storage medium 307 such as a magnetic disk (including a flexible disk), an optical disk (including a compact disc-read only memory (CD-ROM) and a digital versatile disc (DVD)), a magneto-optical disk (including a mini disc (MD)), a semiconductor memory, or the like.

### <Driving History Accumulation Processing>

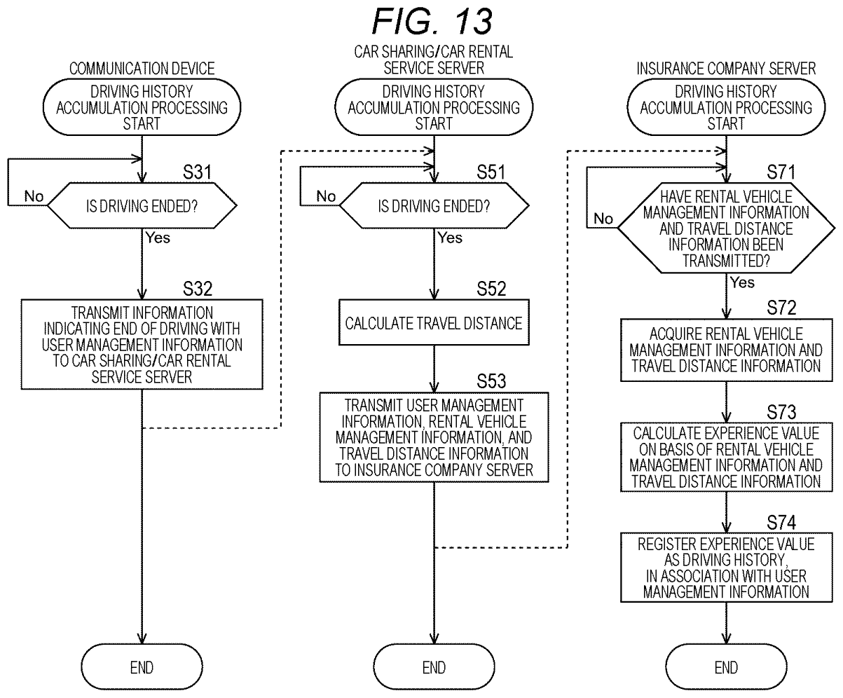

Next, with reference to a flowchart of FIG. 13, driving history accumulation processing in the first embodiment will be described.

Note that, it is premised that contract processing for receiving provision of the car sharing/car rental service is performed between the communication device 211 and the car sharing/car rental service server 212 in advance, by contract management units 261 and 281 on both sides.

Therefore, the contract management unit 281 of the car sharing/car rental service server 212 stores the user management information for identifying the user who possesses the communication device 211, and stores personal information including payment information of the user in association with the user management information.

In step S31, the driving history notification unit 262 determines whether or not a notification has been given indicating that driving of the rental vehicle has been ended and the rental vehicle has been returned by the input unit 242 or the like being operated, and repeats similar processing until the notification is given.

Then, in a case where the notification has been given in step S31 indicating that the driving of the rental vehicle has been ended and the rental vehicle has been returned, the processing proceeds to step S32.

In step S32, the driving history notification unit 262 controls the communication unit 245 to transmit, to the car sharing/car rental service server 212 via the network 221, information indicating that driving of the rental vehicle has been ended and the rental vehicle has been returned together with the user management information of the user who is the renter, together with the rental vehicle management information of the rental vehicle that has been rented.

In step S51, the rental vehicle information management unit 282 of the car sharing/car rental service server 212 controls the communication unit 275 to determine whether or not information has been transmitted indicating that driving of the rental vehicle being rented out has been ended and the rental vehicle has been returned from the communication device 211 via the network 221, and repeats similar processing until the information is transmitted.

In a case where it is determined in step S51 that information has been transmitted indicating that the driving of the rental vehicle being rented out has been ended and the rental vehicle has been returned, the processing proceeds to step S52.

In step S52, the rental vehicle information management unit 282 calculates a travel distance of the returned rental vehicle.

More specifically, when the rental vehicle is returned, for example, the rental vehicle information management unit 282 presents, to the output unit 273, information indicating that the rental vehicle has been returned, and gives an instruction to read out the vehicle inspection certificate and the value of the odometer. On the basis of this instruction, a staff member of the car sharing/car rental service reads out the vehicle inspection certificate and the value of the odometer of the returned rental vehicle, and operates the input unit 272 to input the read value of the odometer and information about the vehicle inspection certificate in association with the rental vehicle management information.

Then, the rental vehicle information management unit 282 calculates a travel distance by reading out a value of the odometer immediately before the vehicle is rented out, which is stored in the rental vehicle information 291 in association with the rental vehicle management information of the returned rental vehicle, and subtracting the read value from the value of the odometer input when the vehicle is returned.

At this time, the rental vehicle information management unit 282 updates, with the input value of the odometer, the value of the odometer stored in the rental vehicle information 291 in association with the rental vehicle management information of the returned rental vehicle, and updates the lending status to be lendable.

Note that, instead of the processing in step S32, the value of the odometer at the start of driving and the value of the odometer at the end of driving when the rental vehicle is returned may be input by the user operating the input unit 242 of the communication device 211, for example, and transmitted to the car sharing/car rental service server 212.

In step S53, the rental vehicle information management unit 282 controls the communication unit 275 to transmit, to the insurance company, the travel distance information and the rental vehicle management information for identifying the rental vehicle rented and driven by the user to the insurance company server 213, in association with the user management information.

In step S71, the driving history management unit 311 of the insurance company server 213 controls the communication unit 305 to determine whether or not the rental vehicle management information and the travel distance information have been transmitted together with the user management information from the car sharing/car rental service server 212, and repeats similar processing until the rental vehicle management information and the travel distance information are transmitted.

When it is determined in step S71 that the rental vehicle management information and the travel distance information have been transmitted together with the user management information, the processing proceeds to step S72.

In step S72, the driving history management unit 311 controls the communication unit 305 to receive and acquire the transmitted rental vehicle management information and travel distance information together with the user management information.

In step S73, the experience value calculation unit 312 calculates an experience value on the basis of the rental vehicle management information and the travel distance information.

More specifically, the experience value calculation unit 312 accesses the vehicle information DB 322 stored in the storage unit 304, reads out information about the vehicle rank item, the equipment item, and the characteristic item related to a vehicle type corresponding to the rental vehicle management information of the returned rental vehicle, calculates an experience value corresponding to travel distance information for each of the vehicle rank item, the equipment item, and the characteristic item described with reference to FIGS. 2 to 4, and updates the experience value lists as indicated by the experience value lists 31 to 34, 51 to 53, 71, and 72.

In step S74, the driving history management unit 311 collects the experience value list of each of the updated vehicle rank item, equipment item, and characteristic item as the driving history, and registers the experience value list in the driving history DB 321 in association with the user management information.

According to the series of processing described above, when the user rents a rental vehicle, a value of the odometer is supplied to the share/car rental service server 212 in association with the rental vehicle management information at the time of return, and a travel distance is obtained according to a difference from a previous odometer value and supplied to the insurance company server 213 together with the rental vehicle management information.

Then, when the rental vehicle management information and the travel distance information are supplied from the car sharing/car rental service server 212, the insurance company server 213 calculates experience values of the vehicle rank item, the equipment item, and the characteristic item of a vehicle type specified on the basis of the rental vehicle management information, updates the experience value list and collects the updated experience value list to generate a driving history, and registers the driving history into the driving history DB 321.

### <Rental Vehicle Presentation Processing>

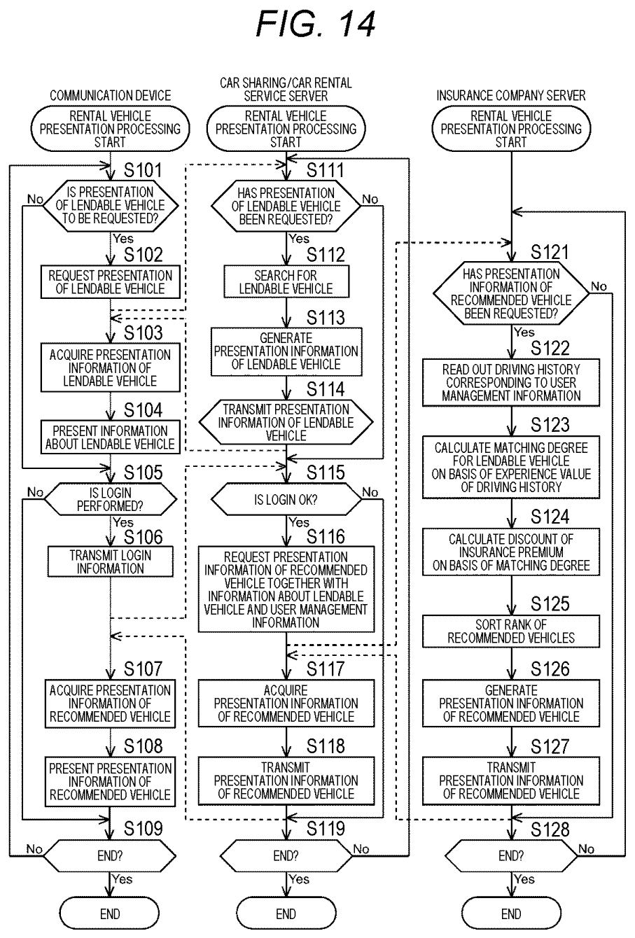

Next, with reference to a flowchart of FIG. 14, rental vehicle presentation processing will be described.

In step S101, the vehicle recommendation unit 263 of the communication device 211 determines whether or not presentation of a lendable vehicle has been requested in using the car sharing/car rental service, by the input unit 242 being operated by the user or the like.

In a case where it is determined in step S101 that presentation of a lendable vehicle has been requested, the processing proceeds to step S102.

In step S102, the vehicle recommendation unit 263 controls the communication unit 245 to request presentation of a lendable vehicle to the car sharing/car rental service server 212 via the network 221.

In step S111, the recommendation information management unit 283 of the car sharing/car rental service server 212 controls the communication unit 275 to determine whether or not presentation of a lendable vehicle has been requested from the communication device 211.

In step S111, when presentation of a lendable vehicle is requested, the processing proceeds to step S112.

In step S112, the recommendation information management unit 283 accesses the rental vehicle information 291 stored in the storage unit 274, to search for a lendable rental vehicle.

In step S113, the recommendation information management unit 283 generates presentation information of a lendable rental vehicle on the basis of a search result.

In step S114, the recommendation information management unit 283 controls the communication unit 275 to transmit the generated presentation information of the lendable rental vehicle, to the communication device 211 that has requested the presentation of the lendable rental vehicle.

In step S103, the vehicle recommendation unit 263 of the communication device 211 controls the communication unit 245 to acquire the presentation information of the lendable rental vehicle transmitted from the car sharing/car rental service server 212.

In step S104, the vehicle recommendation unit 263 displays the acquired presentation information of the lendable rental vehicle on a display unit such as a display of the output unit 243, for example.

Note that, in a case where the presentation information of the lendable vehicle is not requested in step S101, the processing in steps S102 to S104 is skipped. In a case where the presentation information of the lendable vehicle is not requested in step S111, the processing in steps S112 to S114 is skipped.

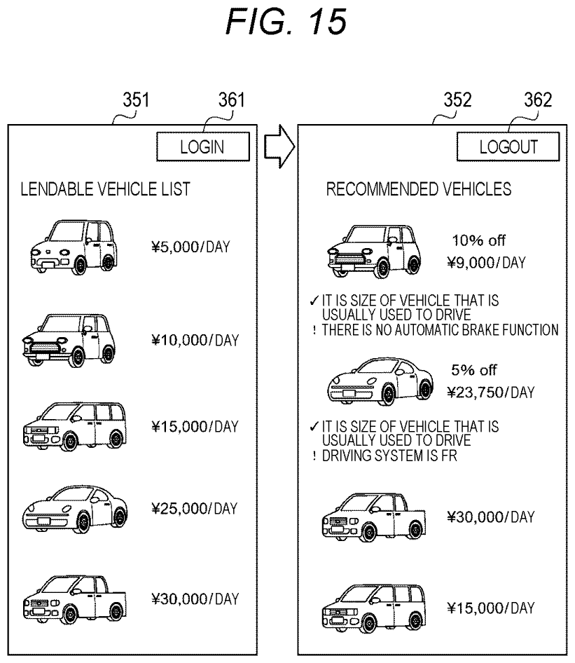

The presentation information of the lendable rental vehicle is, for example, presentation information 351 as illustrated in a left part of FIG. 15.

In the presentation information 351 in the left part of FIG. 15, “Lendable vehicle list” is written in an upper part, images of five lendable vehicles are displayed from the top below the “Lendable vehicle list”, and a usage fee per day is displayed on the right side of the image of the vehicle.

In the presentation information 351 in the left part of FIG. 15, “¥5,000/day” is written on the right side for the vehicle on the top row, indicating that the usage fee per day is 5,000 yen.

Similarly, in presentation information 351, “¥10,000/day” is written on the right side for the vehicle on the second row, “¥15,000/day” is written on the right side for the vehicle on the third row, “¥25,000/day” is written on the right side for the vehicle on the fourth row, and “¥30,000/day” is written on the right side for the vehicle on the fifth row, indicating that the usage fees per day are 10,000 yen, 15,000 yen, 25,000 yen, and 30,000 yen, respectively from the top.

That is, in the example of FIG. 15, the lendable vehicles are simply presented in the list as the “Lendable vehicle list” from the top in the ascending order of the usage fee per day.

Furthermore, a button 361 labeled “login” is provided in the upper right of the presentation information 351, and is a button operated when the user receives provision of the car sharing/car rental service.

When the button 361 is operated, a login screen (not illustrated) is displayed, and it is possible to log in to the car sharing/car rental service server 212 by inputting the user management information and a password.

In the communication device 211, when the login screen (not illustrated) is operated by the user to log in to the car sharing/car rental service server 212, the user management information for specifying the user who operates the communication device 211 and who intends to receive application of the car sharing/car rental service is specified by the car sharing/car rental service server 212.

The car sharing/car rental service server 212 transmits the user management information specified by login to the insurance company server 213 together with information of lendable vehicles, and requests presentation information of a recommended vehicle.

When the presentation information of a recommended vehicle is requested from the car sharing/car rental service server 212, the insurance company server 213 refers to the driving history on the basis of the user management information supplied together, and calculates a usage fee including an insurance premium corresponding to the matching degree for each of the lendable vehicles, and generates and supplies the presentation information of a recommended vehicle to the communication device 211 via the car sharing/car rental service server 212.

Here, the description returns to the description of the flowchart of FIG. 14, for the detailed description.

That is, in step S105, the vehicle recommendation unit 263 of the communication device 211 determines, for example, whether or not the button 361 in FIG. 15 has been operated and the login operation has been performed.

When the button 361 is operated in step S105, the processing proceeds to step S106.

In step S106, the vehicle recommendation unit 263 displays a login screen (not illustrated), receives login information input by operating the input unit 242, and controls the communication unit 245 to transmit the login information to the car sharing/car rental service server 212.

In step S115, the recommendation information management unit 283 of the car sharing/car rental service server 212 controls the communication unit 275 to accept the login information, and determines whether or not the login is OK.

In a case where the login is regarded as OK in step S115, the processing proceeds to step S116.

In step S116, the recommendation information management unit 283 controls the communication unit 275 to transmit, to the insurance company server 213, information requesting presentation information of a recommended vehicle, together with information about a lendable vehicle which is a search result in the processing in step S112, and user management information specified by login.

In step S121, the recommended vehicle determination unit 313 of the insurance company server 213 determines whether or not the presentation information of the recommended vehicle has been requested together with the user management information and the information about the lendable vehicle, from the car sharing/car rental service server 212.

In a case where it is determined in step S121 that the presentation information of the recommended vehicle has been requested together with the user management information and the information about the lendable vehicle, the processing proceeds to step S122.

In step S122, the recommended vehicle determination unit 313 accesses the driving history DB 321 in the storage unit 304, to read out a driving history registered in association with the user management information.

In step S123, the recommended vehicle determination unit 313 calculates a matching degree between with each of the lendable vehicles, on the basis of the experience value of the experience value list registered in the driving history corresponding to the read the user management information.

More specifically, the recommended vehicle determination unit 313 accesses the vehicle information DB 322 of the storage unit 304 to read out the vehicle rank information, the equipment information, and the characteristic information for each of the lendable vehicles, and calculates the matching degree between with each of the lendable vehicles by using the above-described Equation (1), on the basis of the experience value registered in the driving history corresponding to the user management information.

In step S124, the insurance premium determination unit 314 calculates a usage fee in consideration of a discount of an insurance premium according to the matching degree between with each of the lendable vehicles. That is, it can be considered that the user is more familiar with driving of the rental vehicle as the matching degree is higher, and thus, it can be considered that the risk of an accident, damage, or the like is lower. Therefore, the insurance premium determination unit 314 sets an insurance premium obtained by applying a discount to a normal insurance premium, for a rental vehicle having a matching degree higher than a predetermined value.

Then, the recommended vehicle determination unit 313 sets a usage fee of each of the lendable vehicles in consideration of the discount of the insurance premium according to the matching degree.

In step S125, the recommended vehicle determination unit 313 sets a recommendation rank for every recommended vehicle of the lendable vehicles on the basis of the matching degree, and sorts the lendable vehicles in accordance with the recommendation rank.

In step S126, the recommended vehicle determination unit 313 generates presentation information of a recommended vehicle, by adding information about each usage fee and the like to information about the lendable rental vehicles sorted in accordance with the recommendation rank. At this time, the recommended vehicle determination unit 313 may generate the presentation information of the recommended vehicle by adding, for each item in the recommended vehicle, information about an item whose matching degree is higher than a predetermined value or information about an item whose matching degree is lower than the predetermined value.

In step S127, the recommended vehicle determination unit 313 controls the communication unit 305 to transmit the generated presentation information of the recommended vehicle, to the car sharing/car rental service server 212.

In step S117, the recommendation information management unit 283 of the car sharing/car rental service server 212 controls the communication unit 275 to acquire the presentation information of the recommended vehicle transmitted from the insurance company server 213.

In step S118, the recommendation information management unit 283 controls the communication unit 275 to transmit the presentation information of the recommended vehicle supplied from the insurance company server 213, to the communication device 211 that has requested the presentation information of the recommended vehicle.

In step S107, the vehicle recommendation unit 263 of the communication device 211 controls the communication unit 245 to acquire the presentation information of the recommended vehicle supplied from the car sharing/car rental service server 212.

In step S108, the vehicle recommendation unit 263 displays the acquired presentation information of the recommended vehicle, on a display unit such as a display of the output unit 243, for example.

Note that, when login is not performed in step S105, the processing in steps S106 to S108 is skipped.

Furthermore, in step S115, in a case where the login is not OK (including a case where the login information is not transmitted), the processing in steps S116 to S118 is skipped. Here, even when the login information is transmitted in step S106, if the login is NG in step S115, the processing in steps S107 and S108 is also skipped.

Moreover, in step S121, in a case where the presentation information of the recommended vehicle is not requested, the processing in steps S122 to S127 is skipped.

Furthermore, in steps S109, S119, and S128, it is determined whether or not an end of the processing is instructed. In a case where an end the processing is not instructed, the processing returns to steps S101, S111, and S121, respectively, and the subsequent processing is repeated.

Then, in a case where the end of the processing is instructed in steps S109, S119, and S128, the processing ends.

The presentation information of the recommended vehicle is, for example, presentation information 352 as illustrated in a right part of FIG. 15.

In the presentation information 352 in the right part of FIG. 15, “Recommended vehicles” is written in an upper part, and images of four lendable vehicles are presented below the “Recommended vehicle”, from the top in an order according to the above-described matching degree.

That is, since the vehicle at the second row in the presentation information 351 including the lendable vehicle list in the left part of FIG. 15 has the highest matching degree, the vehicle is displayed at the top row in the presentation information 352 of the recommended vehicle in the right part of FIG. 15.

Furthermore, for the vehicle at the top row of the presentation information 352, “10% off ¥9,000/day” is written on the right side of the image of the vehicle, indicating that, as a result of considering a discount of the insurance premium, the usage fee is reduced by 10% from 10,000 yen/day, so that the usage fee per day is 9,000 yen since the matching degree is higher than the predetermined value.

Moreover, under the image of the vehicle, “It is the size of the vehicle that is usually used to drive” is written, expressing that the matching level regarding the corresponding item of the vehicle rank item has been high.

Furthermore, “There is no automatic brake function” is written further below, which clearly indicates that, although the vehicle at the top row has a high overall matching degree with the user, the matching level of the corresponding item of the equipment item is low, and there is no automatic brake function as the equipment item to be cautioned.

Furthermore, since the vehicle at the fourth row in the presentation information 351 including the lendable vehicle list in the left part of FIG. 15 has the second highest matching degree, the vehicle is displayed at the second row in the presentation information 352 of the recommended vehicle in the right part of FIG. 15.

Furthermore, for the vehicle at the second row of the presentation information 352, “5% off ¥23,750/day” is written on the right side of the image of the vehicle, indicating that, as a result of considering a discount of the insurance premium, the usage fee is reduced by 5% from 25,000 yen/day, and the usage fee per day is 23,750 yen since the matching degree is higher than the predetermined value.

Moreover, under the image of the vehicle, “It is the size of the vehicle that is usually used to drive” is written, expressing that the matching level regarding the corresponding item in the vehicle rank item has been high.

Furthermore, “The driving system is FR” is written further below, which clearly indicates that, although the vehicle at the second row has a high overall matching degree with the user, the matching level of the corresponding item in the equipment item is low, and the driving system is FR as the equipment item to be cautioned.

Note that a button 362 labeled “Logout” is provided in the upper right of the presentation information 352, and is operated when the user logs out.

When the button 362 is operated, the user logs out, and the presentation information returns from the presentation information 352 in which the recommended vehicle is presented to the presentation information 351 in which the lendable vehicle list is presented.

According to the above processing, the communication device 211 is operated by the user to display the lendable vehicle list, so that the user can recognize the lendable vehicles when the user receives the car sharing/car rental service.

Furthermore, when the user management information is further specified by logging in to the car sharing/car rental service server 212, the matching degree is calculated for each of the lendable vehicles on the basis of the specified user management information and the corresponding driving history, and it becomes possible to recognize the lendable vehicles with the recommendation rank according to the matching degree.

As a result, the user can select a vehicle that is familiar to the user from among the lendable vehicles, in accordance with the matching degree. Furthermore, at this time, a discount of the insurance premium can be applied to a vehicle having a high matching degree, so that it is possible to receive presentation of a discount fee. Therefore, on the basis of the presentation information of the recommended vehicle, the user can receive recommendation of a vehicle that corresponds to the matching degree, is familiar to the user, and has a lower usage fee according to application of the discount of the insurance premium.

As a result, when renting a vehicle by using the car sharing/car rental service, the user can select a rental vehicle that is familiar to the user at a more reasonable usage fee.

In the above description, an example has been described in which a vehicle having a high matching degree is presented as a recommended vehicle. However, only a vehicle having a matching degree of a predetermined value or more may be presented as a recommended vehicle. In this case, in a case where there is no vehicle having a matching degree of the predetermined value or more, absence of appropriate rental vehicle based on the experience value may be presented.

### 3. First Modification of First Embodiment

Meanwhile, in calculating the matching degree, coefficients corresponding to the individual items are set. In the above processing, an example in which a coefficient set once is used as a fixed value has been described.

By allowing this coefficient to be set according to the user's need, a recommended vehicle may be more suitable for the user's need.

For example, in FIG. 8, the total length, the total width, the total height, the total vehicle weight, the passenger capacity, the steering wheel position, the shift type, the driving system, the automatic brake, the brake play, and the A-pillar angle are set from the top as individual items of the vehicle rank, the equipment, and the characteristic for which the experience values based on the driving history are obtained.

Then, as illustrated in the second column from the left in FIG. 8, setting examples are illustrated such as 0.055556, 0.111111, 0.055556, 0.055556, 0.055556, 0.277778, 0.055556, 0.055556, 0.055556, 0.055556, 0.055556, and 0.111111 from the top as examples of the coefficients set for individual items for which the experience values are obtained.

For example, a case will be considered in which, among these, the user strongly desires that feeling of the brake is close to the rental vehicle that the user usually drives, and puts more importance on the feeling of the brake than other items.

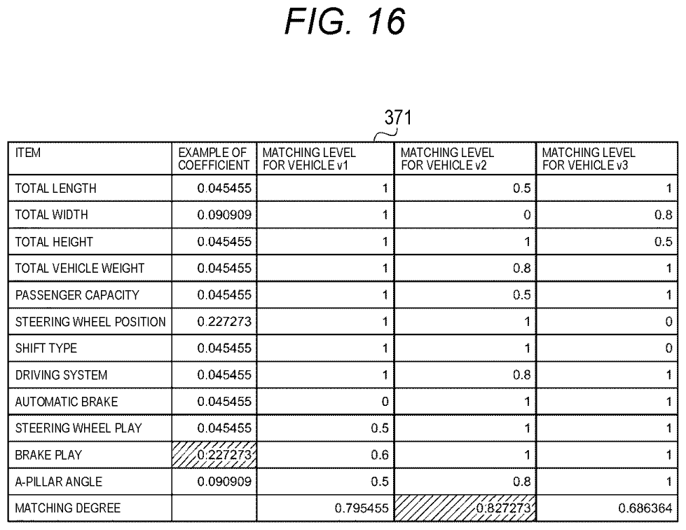

In such a case, as indicated by a list 371 in FIG. 16, a coefficient related to the brake play is set to be large.

That is, although the coefficient related to the brake play in the list 181 of FIG. 8 is set to 0.055556, the coefficient related to the brake play may be set to a large value such as 0.227273, for example, as illustrated in the list 371 of FIG. 16, when there is a request that the item is desired to be regarded as important.

Note that, also in the list 371 of FIG. 16, since Cr (=ΣCri)+Ce (=ΣCej)+Cc (=ΣCck)=1 is satisfied, coefficients of other items are set to be small at the same ratio.

That is, in the list 371 of FIG. 16, the coefficients are 0.045455, 0.090909, 0.045455, 0.045455, 0.045455, 0.227273, 0.055556, 0.045455, 0.045455, 0.045455, 0.227273, and 0.090909 from the top.

As a result, in the case of the example of FIG. 16, the matching degrees of the vehicles V1, V2, and V3 are set to 0.795455, 0.827273, and 0.686364, respectively, in which the matching degree of the vehicle V2 is obtained to be the highest.

Therefore, in the example of the coefficient in FIG. 8, the brake play has the same coefficient as the automatic brake and the steering wheel play, and thus the matching degree of the vehicle V1 has been the highest. On the other hand, in the example of the coefficient in FIG. 16, the matching degree of the vehicle V2 becomes the highest as a result of increasing the coefficient for the brake play.

That is, the matching degree of the vehicle V1 is the highest in a case where the user is not conscious of the feeling of the brake, but the matching degree of the vehicle V2 is the highest when the user is conscious of the feeling of the brake.

In this manner, it is possible to recommend a rental vehicle that matches the user's need, by setting a large coefficient for an item for which the user has preference.

### <Presentation Information of Recommended Vehicle Reflecting User's Need>

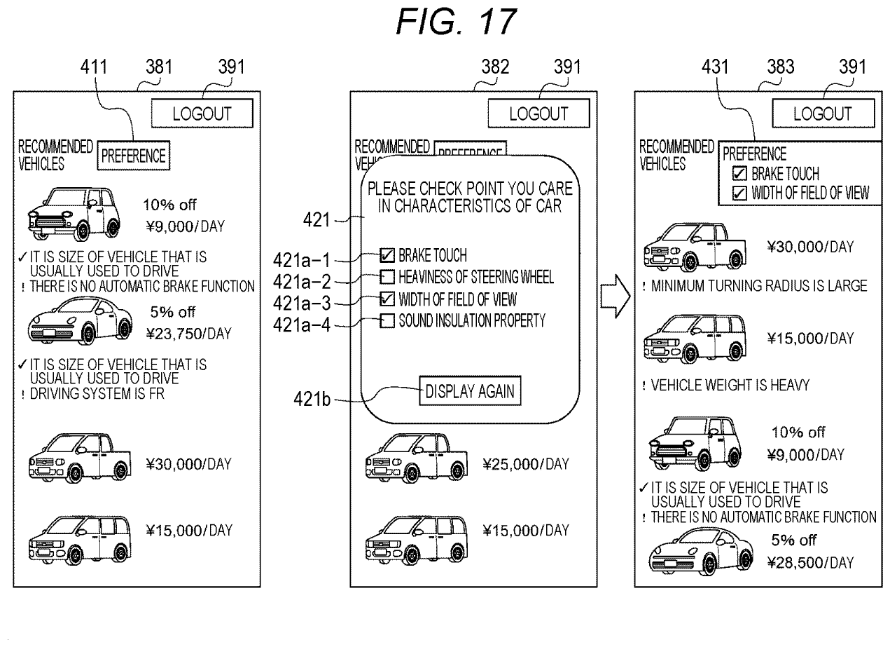

Next, with reference to FIG. 17, a presentation example of presentation information of a recommended vehicle for reflecting the user's need described above will be described.

Note that presentation information 381 in FIG. 17 has a basic configuration corresponding to the presentation information 352 in FIG. 15, in which, for example, a button 391 is similar to the button 361 in FIG. 15.

Here, the presentation information 381 in FIG. 17 is different from the presentation information 351 in FIG. 15 in that a button 411 indicated as “Preference” is newly provided.

The button 411 is a button operated when an item for setting a coefficient according to the user's need described above is selected. For example, when the button is pressed, a pop-up window 421 as indicated in presentation information 382 in FIG. 17 is displayed.

In the pop-up window 421, “Please check the point you care in the characteristics of the car” is written in an upper part, indicating that this pop-up window is a window for selecting an item of preference among the characteristic items.

Check boxes 421a-1 to 421a-4 are displayed from the top under the notation of “Please check the point you care in the characteristics of the car”, and “brake touch”, “heaviness of steering wheel”, “width of field of view”, and “sound insulation property” are written on the right side of the individual check boxes.

That is, the check box 421a-1 is checked in a case where there is preference in the brake touch, and the coefficient of the item of the brake play which is the characteristic item affecting the brake touch is set to be large when the check box 421a-1 is checked.

The check box 421a-2 is checked in a case where there is preference in the heaviness of the steering wheel, and the coefficient of the item of the steering wheel play, which is the characteristic item that affects the heaviness of the steering wheel, is set to be large when check box 421a-2 is checked.

The check box 421a-3 is checked in a case where there is preference in the width of a field of view, and the coefficient of the item of the A-pillar angle, which is the characteristic item that affects the width of a field of view, is set to be large when the check box 421a-3 is checked.

The check box 421a-4 is checked in a case where there is preference in the sound insulation property, and the coefficient of the item of the sound insulation property among the characteristic items is set to be large when the check box 421a-4 is checked.

A button 421b labeled with “Display again” is provided at the bottom row of the pop-up window 421. The button 421b is operated when the matching degree is recalculated after the check boxes 421a-1 to 421a-4 are set, and it is desired to display the presentation information of the recommended vehicle according to the setting.

In the presentation information 382 of FIG. 17, when the button 421b is pressed, the coefficient for the characteristic item of the brake play and the A-pillar angle is set to be large, the matching degree is recalculated, and presentation information 383 is displayed, for example.

In the presentation information 383, a preference item presentation field 431 is provided below the button 391, and an item set by checking one of the check boxes 421a-1 to 421a-4 in the pop-up window 421 of the presentation information 382 is displayed.

The preference item presentation field 431 of FIG. 17 indicates that the check boxes 421a-1 and 421a-3 of the characteristic items of “brake touch” and “width of field of view” are checked in the pop-up window 421 of the presentation information 382.

In the presentation information 383, the vehicles whose matching degrees are obtained as the third and fourth and displayed on the third and fourth rows from the top in the presentation information 381 are displayed on the top row and the second row.

Furthermore, for the vehicle at the top row of the presentation information 383, “Minimum turning radius is large” is written below, which clearly indicates that, although the overall matching degree reflecting the user's preference is the highest, the matching level is lower than a predetermined value when viewed for each item, and the minimum turning radius is large as an item to be cautioned.

Moreover, for the vehicle at the second row of the presentation information 383, “Vehicle weight is heavy” is written below, which clearly indicates that, although the overall matching degree reflecting the user's preference is the highest, the matching level is lower than a predetermined value when viewed for each item, and the vehicle weight is heavy as the item to be cautioned.

In this manner, by setting an item that the user himself/herself desires to emphasize as a characteristic and increasing the coefficient related to the set item, it is possible to recommend a rental vehicle that matches the driving history of the user and the user's need.

Furthermore, even in a case where the coefficient is set according to the user's need in this manner, it is also possible to present the usage fee according to the discount of the insurance premium according to the matching degree, as illustrated in the third and fourth rows of the presentation information 383.

As a result, the user can select a rental vehicle that is according to the user's driving history and user's need, and is also reasonable in terms of the usage fee.

Note that, in the above description, an example has been described in which the coefficient can be set to be large for the characteristic item. However, an item of preference among the vehicle rank item and the equipment item may be set, and the coefficient for the set item may be set to be large.

### <Rental Vehicle Presentation Processing for Realizing Generation of Presentation Information of Recommended Vehicle in FIG. 17>

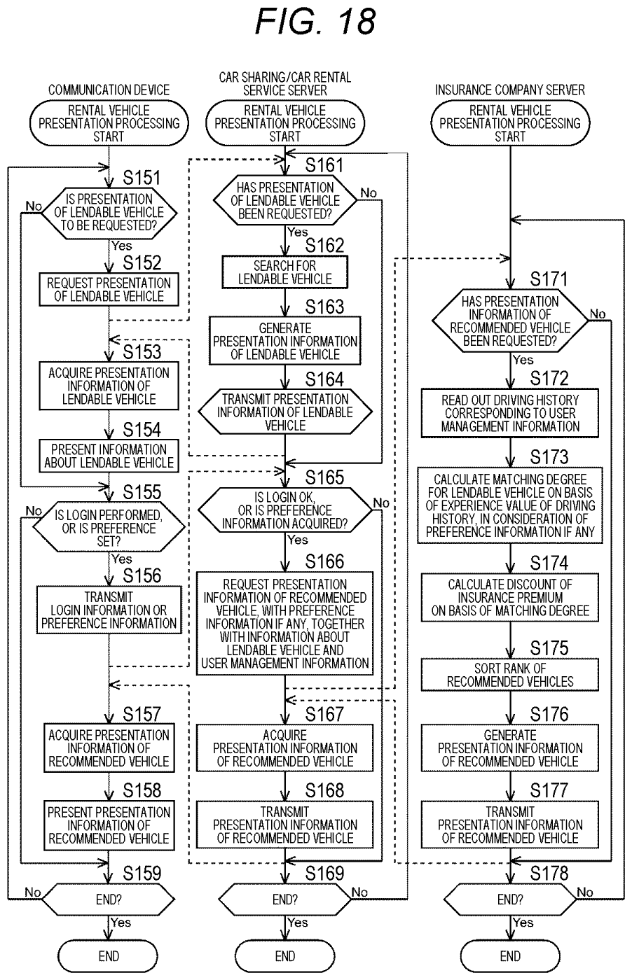

Next, with reference to a flowchart of FIG. 18, rental vehicle presentation processing for realizing generation of presentation information of a recommended vehicle in FIG. 17 will be described.

Note that the processing in steps S151 to S154, the processing in steps S161 to S164, and the processing in steps S159, S169, and S178 in FIG. 18 are similar to the processing in steps S101 to S104, the processing in steps S111 to S114, and steps S109, S119, and S128 in FIG. 14, and thus are appropriately omitted.

That is, in step S155, the vehicle recommendation unit 263 of the communication device 211 determines whether or not the button 391 in FIG. 17 is operated to perform the login operation or the button 411 is operated to set the characteristic item of preference.

In a case where it is determined in step S155 that the button 391 in FIG. 17 is operated to perform the login operation or the button 411 is operated to set the characteristic item of preference, the processing proceeds to step S156.

In step S156, the vehicle recommendation unit 263 displays a login screen (not illustrated), receives login information input by operating the input unit 242, and controls the communication unit 245 to transmit the login information to the car sharing/car rental service server 212.

Alternatively, when the vehicle recommendation unit 263 displays the pop-up window 421, and any one of the check boxes 421a-1 to 421a-4 is checked and the button 421b is pressed, preference information which is information about the characteristic item of preference and is based on presence or absence of the check of the check boxes 421a-1 to 421a-4 is transmitted to the car sharing/car rental service server 212.

In step S165, the recommendation information management unit 283 of the car sharing/car rental service server 212 controls the communication unit 275 to determine whether the login information or the information about the characteristic item of preference has been received.

In a case where the login information is received in step S165, the recommendation information management unit 283 further determines whether or not the login is OK on the basis of the login information, and processing in which the login is determined to be OK proceeds to step S166.

Alternatively, in a case where the preference information is received in step S165, the processing proceeds to step S166.

In step S166, in a case where the login is OK, the recommendation information management unit 283 controls the communication unit 275 to transmit, to the insurance company server 213, information requesting presentation information of a recommended vehicle, together with information about a lendable vehicle which is a search result in the processing in step S162, and user management information specified by the login.

Alternatively, in step S166, in a case where the preference information is received, the recommendation information management unit 283 controls the communication unit 275 to transmit information requesting presentation information of a recommended vehicle obtained by recalculating the matching degree on the basis of the preference information together with the information about the lendable vehicle, which is the search result in the processing in step S162, the user management information, and the preference information to the insurance company server 213.

In step S171, the recommended vehicle determination unit 313 of the insurance company server 213 controls the communication unit 305 to determine whether or not information requesting the presentation information of the recommended vehicle has been received together with the user management information and the information about the lendable vehicle, from the car sharing/car rental service server 212.

At this time, the recommended vehicle determination unit 313 controls the communication unit 305 to also determine whether or not information requesting the presentation information of the recommended vehicle has been received together with the preference information, in addition to the user management information and the lendable vehicle information.

In a case where it is determined in step S171 that the presentation information of the recommended vehicle has been requested together with the user management information and the information about the lendable vehicle, the processing proceeds to step S172.

In step S172, the recommended vehicle determination unit 313 accesses the driving history DB 321 in the storage unit 304, to read out the driving history registered in association with the user management information.

In step S173, the recommended vehicle determination unit 313 calculates a matching degree between with each of the lendable vehicles, on the basis of the experience value registered in the driving history corresponding to the read user management information. At this time, in a case where the preference information is also supplied, the recommended vehicle determination unit 313 sets the coefficient to be larger than a predetermined value for an item included in the preference information as described above, and recalculates the matching degree between with each of the lendable vehicles.

In step S174, the insurance premium determination unit 314 calculates a usage fee in consideration of a discount of an insurance premium according to the matching degree between with each of the lendable vehicles. Then, the recommended vehicle determination unit 313 sets again a usage fee of each of the lendable vehicles in consideration of the discount of the insurance premium according to the matching degree.

In step S175, the recommended vehicle determination unit 313 sets a recommendation rank for every recommended vehicle of the lendable vehicles on the basis of the matching degree, and sorts the lendable vehicles in accordance with the recommendation rank.

In step S176, the recommended vehicle determination unit 313 generates presentation information of a recommended vehicle on the basis of information about the lendable rental vehicles sorted according to the recommendation rank. Note that, regarding the generated presentation information of the recommended vehicle, the presentation information 381 in FIG. 17 is generated, for example, in a case where there is no preference information, while the presentation information 383 in FIG. 17 is generated, for example, in a case where and there is preference information.

In step S177, the recommended vehicle determination unit 313 controls the communication unit 305 to transmit the generated presentation information of the recommended vehicle, to the car sharing/car rental service server 212.

In step S167, the recommendation information management unit 283 of the car sharing/car rental service server 212 controls the communication unit 275 to acquire the presentation information of the recommended vehicle transmitted from the insurance company server 213.

In step S168, the recommendation information management unit 283 controls the communication unit 275 to transmit the presentation information of the recommended vehicle supplied from the insurance company server 213, to the communication device 211 that has requested the presentation information of the recommended vehicle.

In step S157, the vehicle recommendation unit 263 of the communication device 211 controls the communication unit 245 to acquire the presentation information of the recommended vehicle supplied from the car sharing/car rental service server 212.

In step S158, the vehicle recommendation unit 263 displays the acquired presentation information of the recommended vehicle, on a display unit such as a display of the output unit 243, for example.

That is, in a case where the preference information is set by the user, for example, the presentation information of the recommended vehicle as indicated by the presentation information 383 in FIG. 17 is displayed by the processing in step S158.

According to the above processing, it becomes possible to present the presentation information of the recommended vehicle after increasing the coefficient of the characteristic item of preference and recalculating the matching degree, only by the user selecting the characteristic item of preference from among the lendable vehicles.

As a result, the user can receive recommendation of a rental vehicle that corresponds to the user's driving history and the characteristic item of user's preference, and is a vehicle that is relatively familiar to the user, in consideration of item for which the user has preference.

As a result, when renting a vehicle by using the car sharing/car rental service, the user can select a rental vehicle that is familiar to the user in consideration of user's preference.

### 4. Second Modification of First Embodiment

### <Driving History Accumulation Processing Using Imaging Unit of Communication Device>

In the above description, an example has been described in which, in the driving history accumulation processing, the communication device 211 notifies the car sharing/car rental service server 212 of an end of driving, and a staff member of the car sharing/car rental service reads out and inputs the vehicle inspection certificate and a value of the odometer.

However, at a start and an end of driving of a rental vehicle in the car sharing/car rental service, the automobile inspection certificate (vehicle inspection certificate) and the value of the odometer may be imaged by the imaging unit 248 of the communication device 211 as information for identifying the rental vehicle, and transmitted to the car sharing/car rental service server 212.

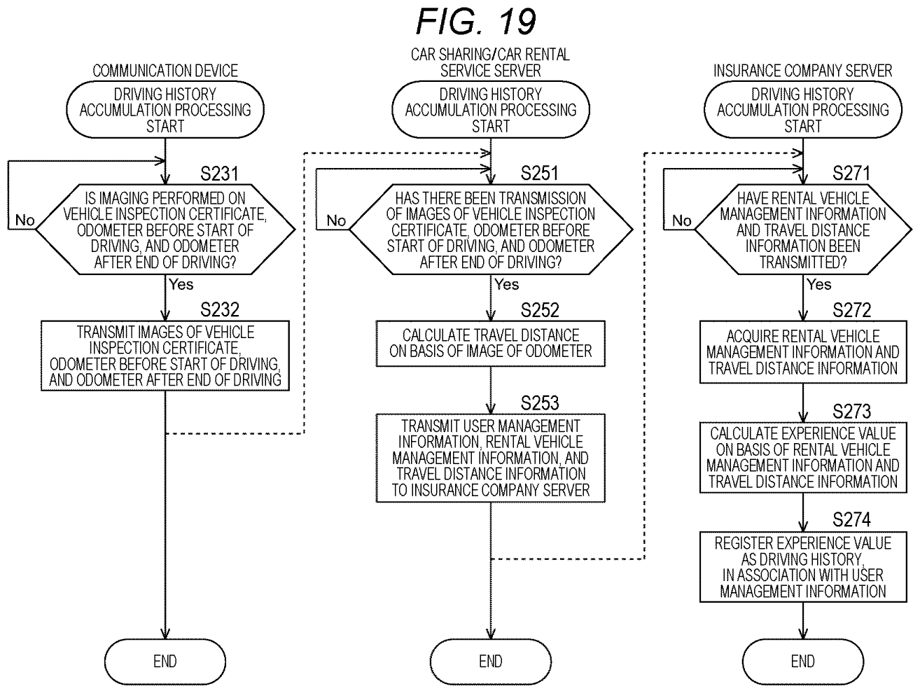

Here, with reference to a flowchart of FIG. 19, driving history accumulation processing using the imaging unit 248 of the communication device 211 will be described.

Note that the processing in steps S253 and S271 to S274 in the flowchart of FIG. 19 is similar to the processing in steps S53 and S71 to S74 in the flowchart of FIG. 13, and thus the description thereof will be omitted.

That is, in step S231, the driving history notification unit 262 of the communication device 211 determines whether or not the imaging unit 248 is operated to image a vehicle inspection certificate (automobile inspection certificate), a value of the odometer before a start of driving and a value of the odometer after an end of driving of the rental vehicle, and repeats similar processing until it is determined that imaging has been performed.

More specifically, after the imaging unit 248 of the communication device 211 is operated by the user to image the vehicle inspection certificate (automobile inspection certificate) and the value of the odometer before the start of driving and the value of the odometer after the end of driving of the rental vehicle, it is determined whether or not the input unit 242 is operated by the user or the like to input information indicating that imaging is performed on the vehicle inspection certificate (automobile inspection certificate) and the value of the odometer before the start of driving and the value of the odometer after the end of driving of the rental vehicle.

Then, in a case where it is determined in step S231 that imaging is performed on the vehicle inspection certificate (automobile inspection certificate) and the value of the odometer before the start of driving and the value of the odometer after the end of driving of the rental vehicle, the processing proceeds to step S232.

In step S232, the driving history notification unit 262 controls the communication unit 245 to transmit captured images of the vehicle inspection certificate (automobile inspection certificate) and the value of the odometer before the start of driving and the value of the odometer after the end of driving of the rental vehicle together with the user management information of the user who is a renter, to the car sharing/car rental service server 212 via the network 221.

As the image of the value of the odometer after the end of driving is captured, a notification indicating that the driving of the rental vehicle has been ended and the rental vehicle has been returned is practically given.

In step S251, the rental vehicle information management unit 282 of the car sharing/car rental service server 212 controls the communication unit 275 to determine whether or not there has been transmission of the captured images of the vehicle inspection certificate (automobile inspection certificate) and the value of the odometer before the start of driving and the value of the odometer after the end of driving of the rental vehicle from the communication device 211 via the network 221, and repeats similar processing until the captured image is transmitted.

In a case where it is determined in step S251 that there has been transmission of the captured images of the vehicle inspection certificate (automobile inspection certificate) and the value of the odometer before the start of driving and the value of the odometer after the end of driving of the rental vehicle, the processing proceeds to step S252.

In step S252, on the basis of the value of the odometer before the start of driving and the value of the odometer after the end of driving of the rental vehicle among the transmitted images of the vehicle inspection certificate (automobile inspection certificate) and the value of the odometer before the start of driving and the value of the odometer after the end of driving of the rental vehicle, the rental vehicle information management unit 282 calculates a travel distance of the returned rental vehicle on the basis of a difference between the values of the odometer.

At this time, the rental vehicle information management unit 282 updates, with the value of the odometer after the end of driving, a value of the odometer that is stored in the rental vehicle information 291 in association with the rental vehicle management information of the returned rental vehicle specified by the information about the vehicle inspection certificate, and the rental vehicle information management unit 282 updates a lending status to be lendable.

Then, in step S253, the rental vehicle information management unit 282 controls the communication unit 275 to transmit, to the insurance company server 213, the travel distance information and the rental vehicle management information for identifying the rental vehicle rented and driven by the user, in association with the user management information.

According to the above processing, it is possible to quickly accumulate the driving history by eliminating time and effort for reading out and inputting the value of the odometer by the staff member of the car sharing/car rental service, after the rental vehicle is returned.

### 5. Second Embodiment

In the above description, an example has been described in which the value of the odometer after the end of driving of the rental vehicle is read out by a staff member of the car sharing/car rental service or is acquired by imaging by using the imaging unit 248 of the communication device 211 by the user.

However, the value of the odometer may be acquired using a scan tool that is used for on-board diagnostics (OBD).

In a case where the OBD is used, a vehicle identification number (VIN) including a serial number that is used to identify a vehicle and a value of the odometer for acquiring a travel distance are acquired at a start of traveling and at an end of driving.

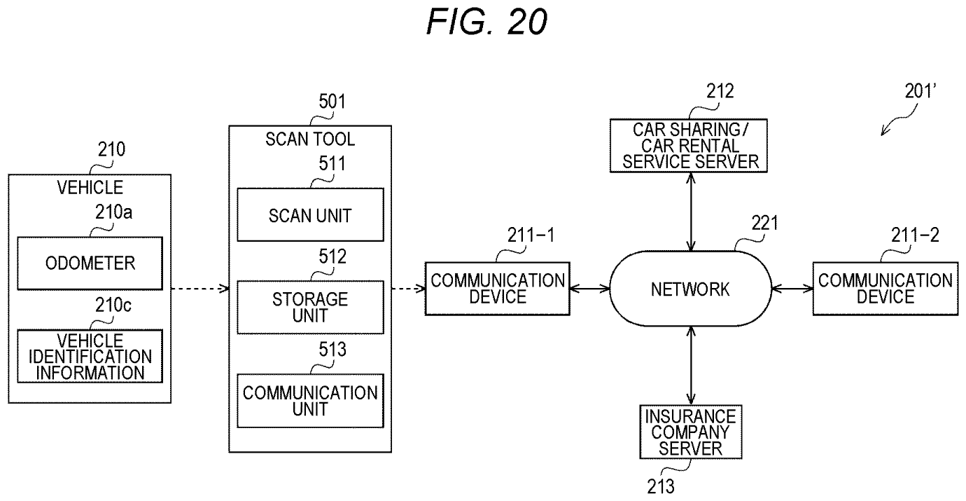

FIG. 20 is a configuration example of a second embodiment of a rental vehicle recommendation system capable of reading a driving history by using a scan tool.

Note that, in a rental vehicle recommendation system 201′ in FIG. 20, configurations having the same functions as those of the rental vehicle recommendation system 201 of FIG. 9 are denoted by the same reference numerals, and the description thereof will be appropriately omitted.

That is, the rental vehicle recommendation system 201′ in FIG. 20 is different from the rental vehicle recommendation system 201 in FIG. 9 in that a scan tool 501 is provided.

The scan tool 501 reads out various pieces of detection information including abnormality data detected in various auxiliary devices (not illustrated) provided in a vehicle 210. In the rental vehicle recommendation system 201′ in FIG. 20, the scan tool 501 reads out vehicle identification information (VIN) and individual values of the odometer at a start and an end of driving from the vehicle 210, and supplies to the communication device 211 through near field communication.

More specifically, the scan tool 501 includes a scan unit 511, a storage unit 512, and a communication unit 513.

The scan unit 511 reads out detection results including abnormality data detected in various auxiliary devices (not illustrated) provided in the vehicle 210. Here, the scan unit 511 reads out the values of an odometer 210a at a start and an end of driving of the vehicle 210, and vehicle identification information (VIN) 210c.

The storage unit 512 includes a memory and the like, and stores the read values of the odometer 210a at the start and the end of driving and the vehicle identification information (VIN) 210c.

For example, the communication unit 513 transmits the values of the odometer 210a at the start and the end of driving and the vehicle identification information (VIN) 210c stored in the storage unit 512, to a communication device 211-1 through short-range communication such as Bluetooth (registered trademark) communication. Note that it is premised that the communication unit 513 and the communication device 211-1 are paired in advance.

In the rental vehicle recommendation system 201′ in FIG. 20, the communication device 211-1 acquires the values of the odometer 210a at the start and the end of driving and the vehicle identification information (VIN) 210c supplied from the scan tool 501, and transmits to a car sharing/car rental service server 212. The processing of the car sharing/car rental service server 212 and an insurance company server 213 is similar to that of the rental vehicle recommendation system 201 of FIG. 9. However, in identifying a rental vehicle, vehicle identification information is used in association with the rental vehicle management information.

### <Driving History Accumulation Processing Performed by Vehicle Recommendation System in FIG. 20>

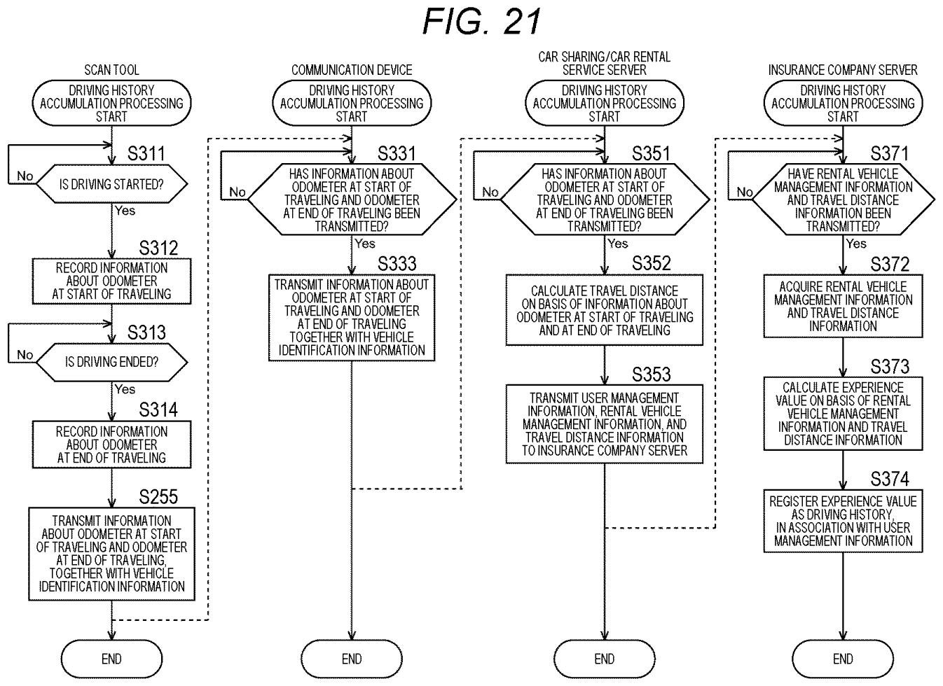

Next, with reference to a flowchart in FIG. 21, driving history accumulation processing performed by the rental vehicle recommendation system 201′ in FIG. 20 will be described.

Note that the processing in steps S353 and S371 to S374 in the flowchart of FIG. 21 is similar to the processing in steps S53 and S71 to S74 in the flowchart of FIG. 13, and thus the description thereof will be omitted.

In step S311, the scan unit 511 of the scan tool 501 determines whether or not the vehicle 210 is rented out and driving is started, and repeats similar processing until it is determined that driving is started. For example, the scan tool 501 may detect activation of an engine to determine the start of driving, or may determine the start of driving on the basis of whether or not the vehicle 210 has started to move from a location of being rented out, by using a global positioning system (GPS) (not illustrated) or the like.

In a case where it is determined in step S311 that driving is started, the processing proceeds to step S312.

In step S312, the scan unit 511 reads out a value of the odometer at the start of driving, and records the value in the storage unit 512.

In step S313, the scan unit 511 determines, for example, whether or not driving of the vehicle 210 is ended, and repeats similar processing until it is determined that driving is ended. For example, the scan tool 501 may detect stop of the engine to determine the end of driving, or may determine the end of driving on the basis of whether or not the vehicle 210 has returned to the location of being rented out, by using a global positioning system (GPS) (not illustrated) or the like.

In a case where it is determined in step S313 that the driving is ended, the processing proceeds to step S314.

In step S314, the scan unit 511 reads out a value of the odometer at the end of driving, and records the value in the storage unit 512.

In step S315, the scan unit 511 reads out the vehicle identification information (VIN), and causes the storage unit 512 to store the vehicle identification information (VIN). Then, the communication unit 513 reads out the vehicle identification information (VIN) stored in the storage unit 512 and the values of the odometer at the start and the end of driving, and transmits to the communication device 211.

In step S331, a driving history notification unit 262 of the communication device 211 controls the communication unit 245 to determine whether or not the vehicle identification information (VIN) and the values of the odometer at the start and the end of driving have been transmitted from the scan tool 501, and repeats similar processing until it is determined that the transmission is performed.

When the vehicle identification information (VIN) and the values of the odometer at the start and the end of driving are transmitted in step S331, the processing proceeds to step S332.

In step S332, the driving history notification unit 262 controls the communication unit 245 to acquire the vehicle identification information (VIN) and the values of the odometer at the start and the end of driving transmitted from the scan tool 501, and transmits the vehicle identification information (VIN) and the values together with user management information of the user who is the renter, to the car sharing/car rental service server 212 via a network 221.

In step S351, a rental vehicle information management unit 282 of the car sharing/car rental service server 212 controls the communication unit 275 to determine whether or not transmission is performed on the vehicle identification information (VIN) and the value of the odometer before the start of driving and the value of the odometer after the end of driving of the rental vehicle, from the communication device 211 via the network 221, and repeats similar processing until the transmission is performed.

In a case where it is determined in step S351 that the transmission is performed on the vehicle identification information (VIN) and the value of the odometer before the start of driving and the value of the odometer after the end of driving of the rental vehicle, the processing proceeds to step S352.

In step S352, among the transmitted vehicle identification information (VIN), values of the odometer before the start of driving and after the end of driving of the rental vehicle, the rental vehicle information management unit 282 calculates a travel distance of the returned rental vehicle on the basis of a difference between both, on the basis of the value of the odometer before the start of driving and the value of the odometer after the end of driving of the rental vehicle.

At this time, the rental vehicle information management unit 282 updates, with the value of the odometer after the end of driving, a value of the odometer that is stored in rental vehicle information 291 in association with the rental vehicle management information of the returned rental vehicle specified by the vehicle identification information, and the rental vehicle information management unit 282 updates a lending status to be lendable.

Then, in step S353, the rental vehicle information management unit 282 controls the communication unit 275 to transmit, to the insurance company server 213, the travel distance information and the rental vehicle management information for identifying the rental vehicle rented and driven by the user, in association with the user management information.

According to the above processing, it is possible to quickly and easily accumulate the driving history without time and effort for reading out and inputting the value of the odometer by the staff member of the car sharing/car rental service after the rental vehicle is returned, and time and effort for transmitting the vehicle inspection certificate and the captured image of the odometer by the user.

### 6. Example of Execution by Software

Incidentally, the series of processing described above can be executed by hardware, but can also be executed by software. In a case where the series of processing is executed by software, a program constituting the software is installed from a recording medium into, for example, a computer built into dedicated hardware or a general-purpose computer that is capable of executing various functions by installing various programs, or the like.

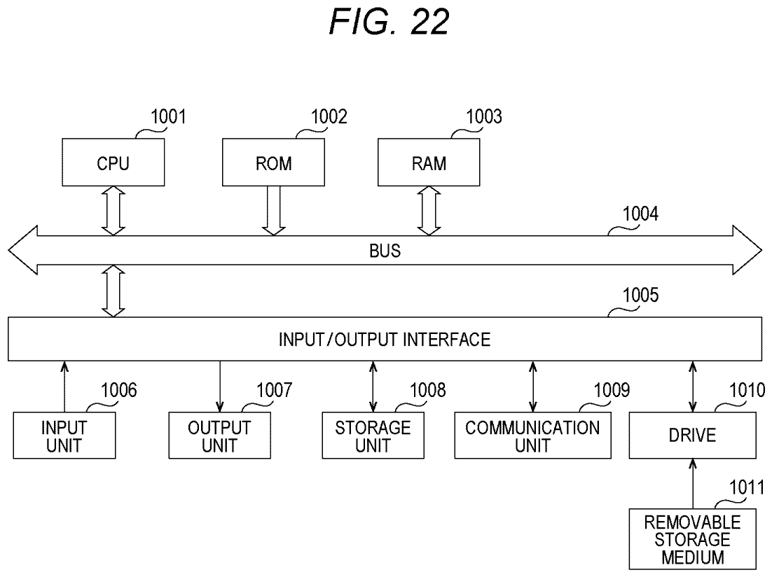

FIG. 22 illustrates a configuration example of a general-purpose computer. This computer includes a central processing unit (CPU) 1001. An input/output interface 1005 is connected to the CPU 1001 via a bus 1004. A read only memory (ROM) 1002 and a random access memory (RAM) 1003 are connected to the bus 1004.

To the input/output interface 1005, an input unit 1006 including an input device such as a keyboard and a mouse by which a user inputs operation commands, an output unit 1007 that outputs a processing operation screen and an image of a processing result to a display device, a storage unit 1008 that includes a hard disk drive and the like and stores programs and various data, and a communication unit 1009 including a local area network (LAN) adapter or the like and executes communication processing via a network represented by the Internet are connected. Furthermore, a drive 1010 that reads and writes data from and to a removable storage medium 1011 such as a magnetic disk (including flexible disk), an optical disk (including compact disc-read only memory (CD-ROM) and digital versatile disc (DVD)), a magneto-optical disk (including Mini Disc (MD)), or a semiconductor memory is connected.

The CPU 1001 executes various processing in accordance with a program stored in the ROM 1002, or a program read from the removable storage medium 1011 such as a magnetic disk, an optical disk, a magneto-optical disk, or a semiconductor memory, installed in the storage unit 1008, and loaded from the storage unit 1008 into the RAM 1003. Furthermore, the RAM 1003 also appropriately stores data necessary for the CPU 1001 to execute various processes, and the like.

In the computer configured as described above, for example, the CPU 1001 loads the program stored in the storage unit 1008 into the RAM 1003 via the input/output interface 1005 and the bus 1004 and executes the program, to thereby perform the above-described series of processing.

The program executed by the computer (CPU 1001) can be provided by being recorded in the removable storage medium 1011 as a package medium or the like, for example. Furthermore, the program can be provided via a wired or wireless transmission medium such as a local area network, the Internet, or digital satellite broadcasting.

In the computer, the program can be installed in the storage unit 1008 via the input/output interface 1005 by mounting the removable storage medium 1011 to the drive 1010. Furthermore, the program can be received by the communication unit 1009 via a wired or wireless transmission medium and installed in the storage unit 1008. Furthermore, the program can be installed in the ROM 1002 or the storage unit 1008 in advance.

Note that, a program to be executed by the computer may be a program by which processes are performed in time series in the order described in the present specification, or may be a program by which processes are performed in parallel or a process may be performed at a required time such as when a call is made.

Note that the CPU 1001 in FIG. 22 implements the functions of the control unit 241 in FIG. 10, the control unit 271 in FIG. 11, and the control unit 301 in FIG. 12.

Furthermore, in the present specification, a system is intended to mean assembly of a plurality of components (devices, modules (parts), and the like) and it does not matter whether or not all the components are in the same casing. Therefore, a plurality of devices housed in separate housings and connected to each other via a network and one device in which a plurality of modules is housed in one housing are both systems.

Note that embodiments of the present disclosure are not limited to the embodiment described above, and various modifications may be made without departing from the scope of the present disclosure.

For example, the present disclosure can have a configuration of cloud computing in which one function is shared by a plurality of devices via a network and processing is performed in cooperation.

Furthermore, each step described in the above flowcharts can be performed by one device, or can be performed in a shared manner by a plurality of devices.

Moreover, in a case where a plurality of processes is included in one step, the plurality of the processes included in the one step can be executed by one device or shared and executed by a plurality of devices.

Note that the present disclosure may have the following configurations.
<1> An information processing apparatus including:
an experience value calculation unit configured to calculate an experience value of a user on the basis of a driving history and a vehicle type of a vehicle driven by the user; and
a generation unit configured to generate recommendation information of the vehicle on the basis of an experience value of the user.
<2> The information processing apparatus according to <1>, in which
the generation unit
calculates a matching degree for each selectable vehicle on the basis of an experience value for each feature item according to a vehicle type of a vehicle driven by the user, and
generates recommendation information of the vehicle from the selectable vehicle on the basis of the matching degree.
<3> The information processing apparatus according to <2>, in which
the generation unit
calculates a matching level for each feature item of the selectable vehicle on the basis of an experience value for each the feature item according to a vehicle type of a vehicle driven by the user,
calculates a matching degree for each the selectable vehicle on the basis of a matching level for each the feature item, and
generates recommendation information of the vehicle from the selectable vehicle on the basis of the matching degree.
<4> The information processing apparatus according to <3>, in which
the generation unit
calculates a matching level for each feature item of the selectable vehicle on the basis of an experience value for each the feature item according to a vehicle type of a vehicle driven by the user,
calculates a matching degree for each the selectable vehicle on the basis of a matching level for each the feature item and a coefficient set for each the feature item, and
generates recommendation information of the vehicle from the selectable vehicle on the basis of the matching degree.
<5> The information processing apparatus according to <4>, in which
the generation unit
calculates a matching level for each feature item of the selectable vehicle on the basis of an experience value for each the feature item according to a vehicle type of a vehicle driven by the user,
calculates a matching degree for each the selectable vehicle on the basis of a product-sum of a matching level for each the feature item and a coefficient set for each the feature item, and
generates recommendation information of the vehicle from the selectable vehicle on the basis of the matching degree.
<6> The information processing apparatus according to <5>, in which
the generation unit
receives an input of information designating the feature item focused on by the user among the feature items,
sets the coefficient of the feature item designated as the focused feature item to a value larger than a predetermined value, and then calculates a matching degree for each the selectable vehicle on the basis of a product-sum of a matching level for each the feature item and a coefficient for each the feature item, and
generates recommendation information of the vehicle from the selectable vehicle on the basis of the matching degree.
<7> The information processing apparatus according to <5>, in which
the generation unit generates the recommendation information on the basis of a rank of the matching degree from the selectable vehicle.
<8> The information processing apparatus according to any one of <2> to <7>, further including:
an insurance premium setting unit configured to set an insurance premium of the selectable vehicle on the basis of the matching degree, in which
the generation unit sets a usage fee including an insurance premium set by the insurance premium setting unit, and recommendation information of the vehicle presents information about the vehicle that is selectable, together with the usage fee in an order based on a rank of the matching degree.
<9> The information processing apparatus according to <8>, in which
the insurance premium setting unit sets an insurance premium of the selectable vehicle to be lower as the matching degree is higher.
<10> The information processing apparatus according to any one of <2> to <9>, in which
the feature item includes a vehicle rank item, an equipment item, and a characteristic item for each vehicle type of the vehicle.
<11> The information processing apparatus according to <10>, in which
the vehicle rank item includes a total length, a total width, a total height, a total vehicle weight, a minimum turning radius, a passenger capacity, a wheelbase, and a front/rear overhang, of the vehicle,
the equipment item includes a shift type, a driving system, presence or absence of an automatic brake, a steering wheel position, presence or absence of adaptive cruise control (ACC), presence or absence of lane keep assist (LKA), steering wheel telescopic/tilt, and a tire size, of the vehicle, and
the characteristic item includes a brake play, an A-pillar angle, heaviness of a steering wheel, a conversion rate between a rotation angle of a steering wheel and an angle of a tire, strength of a brake, and a sound insulation property, of the vehicle.
<12> The information processing apparatus according to <10>, in which
the experience value calculation unit calculates a travel distance, travel time, a number of times of traveling, or a travel frequency, as an experience value of the user, on the basis of a driving history of a vehicle driven by the user.
<13> An information processing method including:
a step of calculating an experience value of a user on the basis of a driving history and a vehicle type of a vehicle driven by the user; and
a step of generating recommendation information of the vehicle on the basis of an experience value of the user.
<14> An information processing apparatus including:
a transmission unit configured to transmit a driving history and a vehicle type of a vehicle driven by a user to another information processing apparatus; and
a recommendation unit configured to acquire and present recommendation information of the vehicle, the recommendation information being generated in the another information processing apparatus, on the basis of the vehicle type and the driving history.
<15> The information processing apparatus according to <14>, in which
the transmission unit transmits, as the vehicle type and the driving history, information about an automobile inspection certificate of the vehicle, a value of an odometer at a start of driving of the vehicle, and a value of the odometer at an end of driving of the vehicle.
<16> The information processing apparatus according to <14>, further including:
an imaging unit configured to capture an image, in which
the transmission unit transmits, as the vehicle type and the driving history, an image of an automobile inspection certificate of the vehicle, an image of a value of an odometer at a start of driving of the vehicle, and an image of a value of the odometer at an end of driving of the vehicle, the images being captured by the imaging unit.
<17> The information processing apparatus according to <14>, further including:
a scan tool configured to scan failure diagnosis information of the vehicle, in which
the transmission unit transmits, as the vehicle type and the driving history, vehicle identification information of the vehicle, a value of an odometer at a start of driving of the vehicle, and a value of the odometer at an end of driving of the vehicle, in which the vehicle identification information and the values of the odometer are scanned by the scan tool.
<18> The information processing apparatus according to <14>, in which
in generating recommendation information of the vehicle, the transmission unit further transmits information designating a feature item according to the vehicle type to the another information processing apparatus, the feature item being focused on by the user, and the recommendation unit acquires and presents recommendation information of the vehicle in consideration of a feature item according to the vehicle type, the feature item being focused on by the user, the recommendation information being supplied from the another information processing apparatus.
<19> An information processing method including:
a step of transmitting a driving history and a vehicle type of a vehicle driven by a user to another information processing apparatus; and
a step of acquiring and presenting recommendation information of the vehicle, the recommendation information being generated in the another information processing apparatus, on the basis of the vehicle type and the driving history.
<20> A program for causing a computer to function as:
a transmission unit configured to transmit a driving history and a vehicle type of a vehicle driven by a user to another information processing apparatus; and
a recommendation unit configured to acquire and present recommendation information of the vehicle, the recommendation information being generated in the another information processing apparatus, on the basis of the vehicle type and the driving history.

### REFERENCE SIGNS LIST

201 Rental vehicle recommendation system
210 Vehicle
210a Odometer
210b Automobile inspection certificate
211, 211-1, 211-2 Communication device
212 Car sharing/car rental service server
213 Insurance company server
241 Control unit
261 Contract management unit
262 Driving history notification unit
263 Vehicle recommendation unit
271 Control unit
281 Contract management unit
282 Rental vehicle information management unit
283 Recommendation information management unit
291 Rental vehicle information
301 Control unit
311 Driving history management unit
312 Experience value calculation unit
313 Recommended vehicle determination unit
314 Insurance premium determination unit
321 Driving history DB
322 Vehicle information DB
501 Scan tool
511 Scan unit
512 Storage unit
513 Communication unit

1. An information processing apparatus comprising:
an experience value calculation unit configured to calculate an experience value of a user on a basis of a driving history and a vehicle type of a vehicle driven by the user; and
a generation unit configured to generate recommendation information of the vehicle on a basis of an experience value of the user.

2. The information processing apparatus according to claim 1, wherein
the generation unit
calculates a matching degree for each selectable vehicle on a basis of an experience value for each feature item according to a vehicle type of a vehicle driven by the user, and
generates recommendation information of the vehicle from the selectable vehicle on a basis of the matching degree.

3. The information processing apparatus according to claim 2, wherein
the generation unit
calculates a matching level for each feature item of the selectable vehicle on a basis of an experience value for each the feature item according to a vehicle type of a vehicle driven by the user,
calculates a matching degree for each the selectable vehicle on a basis of a matching level for each the feature item, and
generates recommendation information of the vehicle from the selectable vehicle on a basis of the matching degree.

4. The information processing apparatus according to claim 3, wherein
the generation unit
calculates a matching level for each feature item of the selectable vehicle on a basis of an experience value for each the feature item according to a vehicle type of a vehicle driven by the user,
calculates a matching degree for each the selectable vehicle on a basis of a matching level for each the feature item and a coefficient set for each the feature item, and
generates recommendation information of the vehicle from the selectable vehicle on a basis of the matching degree.

5. The information processing apparatus according to claim 4, wherein
the generation unit
calculates a matching level for each feature item of the selectable vehicle on a basis of an experience value for each the feature item according to a vehicle type of a vehicle driven by the user,
calculates a matching degree for each the selectable vehicle on a basis of a product-sum of a matching level for each the feature item and a coefficient set for each the feature item, and
generates recommendation information of the vehicle from the selectable vehicle on a basis of the matching degree.

6. The information processing apparatus according to claim 5, wherein
the generation unit
receives an input of information designating the feature item focused on by the user among the feature items,
sets the coefficient of the feature item designated as the focused feature item to a value larger than a predetermined value, and then calculates a matching degree for each the selectable vehicle on a basis of a product-sum of a matching level for each the feature item and a coefficient for each the feature item, and
generates recommendation information of the vehicle from the selectable vehicle on a basis of the matching degree.

7. The information processing apparatus according to claim 5, wherein
the generation unit generates the recommendation information on a basis of a rank of the matching degree from the selectable vehicle.

8. The information processing apparatus according to claim 2, further comprising:
an insurance premium setting unit configured to set an insurance premium of the selectable vehicle on a basis of the matching degree, wherein
the generation unit sets a usage fee including an insurance premium set by the insurance premium setting unit, and recommendation information of the vehicle presents information about the vehicle that is selectable, together with the usage fee in an order based on a rank of the matching degree.

9. The information processing apparatus according to claim 8, wherein
the insurance premium setting unit sets an insurance premium of the selectable vehicle to be lower as the matching degree is higher.

10. The information processing apparatus according to claim 2, wherein
the feature item includes a vehicle rank item, an equipment item, and a characteristic item for each vehicle type of the vehicle.

11. The information processing apparatus according to claim 10, wherein
the vehicle rank item includes a total length, a total width, a total height, a total vehicle weight, a minimum turning radius, a passenger capacity, a wheelbase, and a front/rear overhang, of the vehicle,
the equipment item includes a shift type, a driving system, presence or absence of an automatic brake, a steering wheel position, presence or absence of adaptive cruise control (ACC), presence or absence of lane keep assist (LKA), steering wheel telescopic/tilt, and a tire size, of the vehicle, and
the characteristic item includes a brake play, an A-pillar angle, heaviness of a steering wheel, a conversion rate between a rotation angle of a steering wheel and an angle of a tire, strength of a brake, and a sound insulation property, of the vehicle.

12. The information processing apparatus according to claim 10, wherein
the experience value calculation unit calculates a travel distance, travel time, a number of times of traveling, or a travel frequency, as an experience value of the user, on a basis of a driving history of a vehicle driven by the user.

13. An information processing method comprising:
a step of calculating an experience value of a user on a basis of a driving history and a vehicle type of a vehicle driven by the user; and
a step of generating recommendation information of the vehicle on a basis of an experience value of the user.

14. An information processing apparatus comprising:
a transmission unit configured to transmit a driving history and a vehicle type of a vehicle driven by a user to another information processing apparatus; and
a recommendation unit configured to acquire and present recommendation information of the vehicle, the recommendation information being generated in the another information processing apparatus, on a basis of the vehicle type and the driving history.

15. The information processing apparatus according to claim 14, wherein
the transmission unit transmits, as the vehicle type and the driving history, information about an automobile inspection certificate of the vehicle, a value of an odometer at a start of driving of the vehicle, and a value of the odometer at an end of driving of the vehicle.

16. The information processing apparatus according to claim 14, further comprising:
an imaging unit configured to capture an image, wherein
the transmission unit transmits, as the vehicle type and the driving history, an image of an automobile inspection certificate of the vehicle, an image of a value of an odometer at a start of driving of the vehicle, and an image of a value of the odometer at an end of driving of the vehicle, the images being captured by the imaging unit.

17. The information processing apparatus according to claim 14, further comprising:
a scan tool configured to scan failure diagnosis information of the vehicle, wherein
the transmission unit transmits, as the vehicle type and the driving history, vehicle identification information of the vehicle, a value of an odometer at a start of driving of the vehicle, and a value of the odometer at an end of driving of the vehicle, in which the vehicle identification information and the values of the odometer are scanned by the scan tool.

18. The information processing apparatus according to claim 14, wherein
in generating recommendation information of the vehicle, the transmission unit further transmits information designating a feature item according to the vehicle type to the another information processing apparatus, the feature item being focused on by the user, and
the recommendation unit acquires and presents recommendation information of the vehicle in consideration of a feature item according to the vehicle type, the feature item being focused on by the user, the recommendation information being supplied from the another information processing apparatus.

19. An information processing method comprising:
a step of transmitting a driving history and a vehicle type of a vehicle driven by a user to another information processing apparatus; and
a step of acquiring and presenting recommendation information of the vehicle, the recommendation information being generated in the another information processing apparatus, on a basis of the vehicle type and the driving history.

20. A program for causing a computer to function as:
a transmission unit configured to transmit a driving history and a vehicle type of a vehicle driven by a user to another information processing apparatus; and a recommendation unit configured to acquire and present recommendation information of the vehicle, the recommendation information being generated in the another information processing apparatus, on a basis of the vehicle type and the driving history.
